(19) United States
(12) Patent Application Publication
(10) Pub. No.: US 2014/0008352 A1
(43) Pub. Date: Jan. 9, 2014

(54) HEAT TREATMENT APPARATUS

(71) Applicant: HITACHI HIGH-TECHNOLOGIES CORPORATION, TOKYO (JP)

(72) Inventors: Takashi UEMURA, Kudamatsu-shi (JP); Ken'etsu YOKOGAWA, Tsurugashima-shi (JP); Masatoshi MIYAKE, Kudamatsu-shi (JP); Hiromichi KAWASAKI, Shunan-shi (JP)

(73) Assignee: HITACHI HIGH-TECHNOLOGIES CORPORATION, Tokyo (JP)

(21) Appl. No.: 13/928,708

(22) Filed: Jun. 27, 2013

(30) Foreign Application Priority Data
Jul. 3, 2012 (JP) 2012-149219
Jan. 17, 2013 (JP) 2013-005883
Jun. 10, 2013 (JP) 2013-121906

(51) Int. Cl. H05B 6/02

(52) U.S. Cl. CPC H05B 6/02
USPC 219/601

(57) ABSTRACT

In order to provide a heat treatment apparatus that is high in thermal efficiency, and can reduce a surface roughness of a specimen surface even when a specimen is heated at 1200° C. or higher, in a heat treatment apparatus that conducts a heat treatment by the aid of plasma, a heat treatment chamber includes a heating plate that heats a specimen by the aid of the plasma, and an electrode that is applied with a plasma generation radio-frequency power. The heating plate includes a beam, and is connected to the heat treatment chamber through the beam and the thermal expansion absorption member, and the thermal expansion absorption member has an elastic member.

### CLAIM OF PRIORITY

This application is based upon and claims the benefit of priority from the prior Japanese Patent Application No. 2012-149219, filed Jul. 3, 2012, Application No. 2013-005883, filed Jan. 17, 2013, and Application No. 2013-121906, filed Jun. 10, 2013, the entire contents of which are incorporated herein by references into this application.

### BACKGROUND OF THE INVENTION

1. Field of the Invention

The present invention relates to a semiconductor manufacturing apparatus that manufactures a semiconductor device, and relates to a heat treatment technique for conducting activation annealing, defect repair annealing, and the oxidation of a surface after impurity doping, which is conducted for the purpose of controlling the conductivity of a semiconductor substrate.

2. Description of the Related Art

In recent years, the introduction of a new material having a wide band gap such as silicon carbide (hereinafter referred to as “SiC”) has been expected as a substrate material of a power semiconductor device. SiC that is the wide band gap semiconductor has physical properties such as a high dielectric breakdown electric field, a high saturated electron velocity, and a high thermal conductivity, which are better than those of silicon (hereinafter referred to as “Si”). Because of the high dielectric breakdown electric field, SiC enables thinning of the device, and high concentration doping, thereby being capable of producing a device having a high withstand voltage and a low resistance. Also, since thermally excited electrons can be suppressed because the band gap is large, and a radiation performance is high because of the high thermal conductivity, stable operation at a high temperature is enabled. Therefore, if the SiC power semiconductor device is realized, there can be expected a remarkable improvement in efficiency and a high performance of various power/electric devices such as power transport/conversion, industrial power devices, and home electric appliances.

A process for manufacturing various power devices with the use of SiC is almost identical with a process using Si for the substrate. However, a largely different process resides in a heat treatment process. The heat treatment process is represented by activation annealing after the ion implantation of impurities which is conducted for the purpose of controlling the conductivity of the substrate. In the case of the Si device, the activation annealing is conducted at a temperature of 800 to 1200° C. On the other hand, in the case of SiC, a temperature of 1200 to 2000° C. is required because of material characteristics thereof. As an annealing device for the SiC substrate, a resistance heating furnace has been known as disclosed in, for example, Japanese Unexamined Patent Application Publication No. 2009-32774. Also, with the exception of the resistance heating furnace, an annealing device of an induction heating system has been known as disclosed in, for example, Japanese Unexamined Patent Application Publication No. 2010-34481. Further, as a method of suppressing the roughness of an SiC surface caused by annealing, Japanese Unexamined Patent Application Publication No. 2009-231341 discloses a method of installing a cap where SiC is exposed on a portion facing the SiC substrate. Also, Japanese Unexamined Patent Application Publication (Translation of PCT application) No. 2010-517294 discloses a device for heating a wafer through a metal sheath with the help of atmospheric-pressure plasma generated by microwaves.

Also, as the annealing device for the SiC substrate, for example, Japanese Unexamined Patent Application Publication No. 2012-59872 discloses a heat treatment apparatus including parallel plate electrodes 2, 3, a radio-frequency power supply 6 that applies a radio-frequency voltage between those electrodes, and conducts electric discharge, temperature measurement means 17 for measuring a temperature of a specimen 1 to be heated arranged between those electrodes, means 10 for introducing gas between those electrodes, a reflecting mirror 13 that covers the circumference of those electrodes, and a control unit 18 that controls an output of the radio-frequency power supply 6.

### SUMMARY OF THE INVENTION

When heating is conducted at 1200° C. or higher by the resistance heating furnace discloses in Japanese Unexamined Patent Application Publication No. 2009-32774, the following problems are salient.

A first problem resides in thermal efficiency. Because a heat loss from a furnace body is dominated by radiation, and the amount of radiation is increased with the fourth power of the temperature. As a result, if a heating region is larger, an energy efficiency required for heating is extremely lowered. In the case of the resistance heating furnace, in order to avoid contamination from a heater, a double-pipe structure is normally used to increase the heating region. Also, because the specimen to be heated is distant from a heat source (heater) due to the double pipes, there is a need to maintain the heater portion at a high temperature equal to or higher than a temperature of the specimen to be heated. This also causes the efficiency to be largely lowered. Also, for the same reason, a heat capacity of the region to be heated becomes very large, and it takes time for the temperature to rise and drop. Hence, since a time required from carry-in to carry-out of the specimen to be heated becomes long, the throughput is lowered. Also, a time during which the specimen to be heated stays under a high temperature environment becomes long, thereby causing an increase in the surface roughness of the specimen to be heated which will be described later.

A second problem resides in consumption of the furnace material. As the furnace material, a material that can cope with 1200 to 2000° C. is limited, and a material with a high melting point and a high purity is required. The furnace material available for the SiC substrate is graphite or SiC per se. In general, there is used an SiC sintered compact, or a material obtained by coating SiC on a surface of a graphite base material through a chemical vapor deposition. However, those materials are normally expensive, and if the furnace body is large, a considerable expense is required for replacement. Also, since a lifetime of the furnace body becomes shorter as the temperature is higher, the replacement costs are higher than that in a normal Si process.

A third problem resides in the generation of the surface roughness attributable to the evaporation of the specimen to be heated. In heating at about 1800° C., Si is selectively evaporated from the surface of SiC which is the specimen to be heated to roughen the surface, or the doped impurities are removed to obtain no necessary device characteristics. As a countermeasure against the surface roughness of the specimen to be heated attributable to the high temperature, the related art uses a method of forming a carbon film on the surface of the specimen to be heated in advance as a protective film during heating. However, in a method of the related art, the formation and removal of the carbon film in another process are required for the heat treatment with the results that the number of processes is increased, and the costs are increased.

On the other hand, the induction heating system disclosed in Japanese Unexamined Patent Application Publication No. 2010-34481 is a system in which a radio-frequency induced current is allowed to flow into an object to be heated or installing means for installing the object to be heated for heating the object to be heated, and is higher in thermal efficiency than the foregoing resistance heating furnace system. In the case of the induction heating, if the electric resistivity of the object to be heated is low, the induced current necessary for heating becomes large, and a heat loss in an induction coil cannot be ignored. Therefore, the thermal efficiency of the object to be heated is not always high.

Also, in the induction heating system, a heating uniformity is determined according to the induced current that flows into the specimen to be heated or the installing means for installing the object to be heated. Therefore, the heating uniformity may not be sufficiently obtained in a planar disc used in the device manufacture. If the heating uniformity is low, the specimen to be heated may be damaged due to a thermal stress during rapid heating. For that reason, since there is a need to adjust a rising speed of the temperature to an extent that does not generate the stress, the throughput is lowered. Further, as in the resistance heating furnace system, processes of generating and removing a cap film for preventing Si evaporation from the SiC surface at a ultrahigh temperature are additionally required.

Further, in the SiC surface roughness preventing method disclosed in Japanese Unexamined Patent Application Publication No. 2009-231341, Si atoms are withdrawn from the SiC substrate surface due to evaporation under the high temperature environment. However, because Si atoms are also evaporated from a facing surface, the Si atoms emitted from the facing surface are absorbed into a portion of the SiC substrate surface from which Si has been withdrawn, to thereby prevent the surface roughness of the SiC substrate surface. For that reason, the cap disclosed in Japanese Unexamined Patent Application Publication No. 2009-231341 is merely used as a supply source of the Si atoms during heating by the aid of an induction heating coil or a resistance heating heater.

Also, the annealing device disclosed in Japanese Unexamined Patent Application Publication (Translation of PCT application) No. 2010-517294 employs a system in which the specimen to be heated is exposed directly to an atmospheric pressure plasma generated by microwaves so as to be heated, which is different from the above related art. However, because an area in which the plasma is generated is large, the thermal efficiency is low.

Further, when a heat source uses the plasma, if the specimen to be heated is exposed directly to the plasma so as to be heated, a kinetic energy that damages a crystal face is generally 10 electron bolts or more. When the acceleration of ions exceeding this value occurs, the crystal face is damaged by the ions with the results that there is a need to set the energy of the ions input to the specimen to be heated to be equal to or lower than 10 electron bolts. For that reason, the generation conditions of the plasma are limited.

The present invention has been made in view of the above-mentioned problem, and therefore aims at providing a heat treatment apparatus that is high in thermal efficiency, and can reduce the surface roughness of a substrate to be treated (specimen to be heated) even if the substrate is heated at 1200° C. or higher.

According to an embodiment of the present invention, there is provided a heat treatment apparatus having a heat treatment chamber which conducts a heat treatment on a specimen to be heated by the aid of plasma in which the heat treatment chamber includes a heating plate that heats the specimen to be heated due to the plasma; and an electrode that is arranged to face the heating plate, and is applied with a radio-frequency power for generating the plasma, in which the heating plate has a beam, and is connected to the heat treatment chamber through the beam and a thermal expansion absorption member, and the thermal expansion absorption member has an elastic member.

According to the present invention, there can be provided the heat treatment apparatus that is high in thermal efficiency, and can reduce the surface roughness of the substrate to be treated. Further, the stable plasma can be produced. Also, the high productivity can be realized.

### BRIEF DESCRIPTION OF THE DRAWINGS

FIGS. 1A to 1C illustrate a heat treatment apparatus according to a first embodiment, in which FIG. 1A is a basic configuration diagram thereof, FIG. 1B is a top view taken along a cross-section A-A, and FIG. 1C is a top view taken along a cross-section B-B;

FIGS. 2A to 2G are diagrams illustrating a fixed portion of a beam that holds a heating plate of a heat treatment chamber in the heat treatment apparatus according to the first embodiment, in which FIG. 2A is a side view before heating, FIG. 2B is a side view during heating, FIG. 2C is a side view after heating, FIG. 2D is a top view before heating, FIG. 2E is a top view during heating, FIG. 2F is a top view after heating, and FIG. 2G is a front view thereof,

FIG. 3 is a perspective view illustrating the fixed portion of the beam that holds the heating plate of the heat treatment chamber in the heat treatment apparatus according to the first embodiment;

FIG. 4 is a cross-sectional view of an outline of the heat treatment chamber in the heat treatment apparatus according to the first embodiment;

FIG. 5 is a cross-sectional view illustrating an outline of the heat treatment chamber for illustrating carry-in and carry-out of a specimen in the heat treatment apparatus according to the first embodiment;

FIG. 6 is a cross-sectional view of an outline of a heat treatment chamber according to a second embodiment;

FIG. 7 is a top view taken along a cross-section A-A in FIG. 6;

FIG. 8 is a top view taken along a cross-section B-B in FIG. 6;

FIG. 9 is a schematic diagram illustrating a reflecting mirror 120a of an upper portion, a reflecting mirror 120b of a side surface, and a reflecting mirror 120c of a lower portion;

FIG. 10 is a vertical cross-sectional view of an outline of the heat treatment chamber having a reflecting mirror different from a reflecting mirror of FIG. 6;

FIG. 11 is a top view taken along a cross-section A-A in FIG. 10;

FIG. 12 is a top view taken along a cross-section B-B in FIG. 10;

FIG. 13 is a schematic diagram illustrating an upper reflecting mirror 120a of an upper portion, a side reflecting mirror 120b, and a lower reflecting mirror 120c provided in the heat treatment chamber of FIG. 10;

FIG. 14 is a vertical cross-sectional view of an outline of a heat treatment chamber according to a third embodiment;

FIG. 15 is a top view taken along a cross-section A-A in FIG. 14;

FIG. 16 is a top view taken along a cross-section B-B in FIG. 14;

FIG. 17 is a vertical cross-sectional view of an outline of the heat treatment chamber having a reflecting mirror different from a reflecting mirror of FIG. 14;

FIG. 18 is a top view taken along a cross-section A-A in FIG. 17;

FIG. 19 is a top view taken along a cross-section B-B in FIG. 17;

FIG. 20 is a basic configuration diagram of a heat treatment apparatus according to a fourth embodiment;

FIGS. 21A and 21B are cross-sectional views of details of a relay feed line in the heat treatment apparatus according to the fourth embodiment, in which FIG. 21A illustrates a case using a carbon fiber reinforced-carbon matrix-composite, and FIG. 21B illustrates a case using glassy carbon; and

FIG. 22 is a connection diagram of the relay feed line in the heat treatment apparatus according to the fourth embodiment.

### DESCRIPTION OF THE PREFERRED EMBODIMENTS

Embodiments of the present invention will be described below with reference to the accompanying drawings.

### First Embodiment

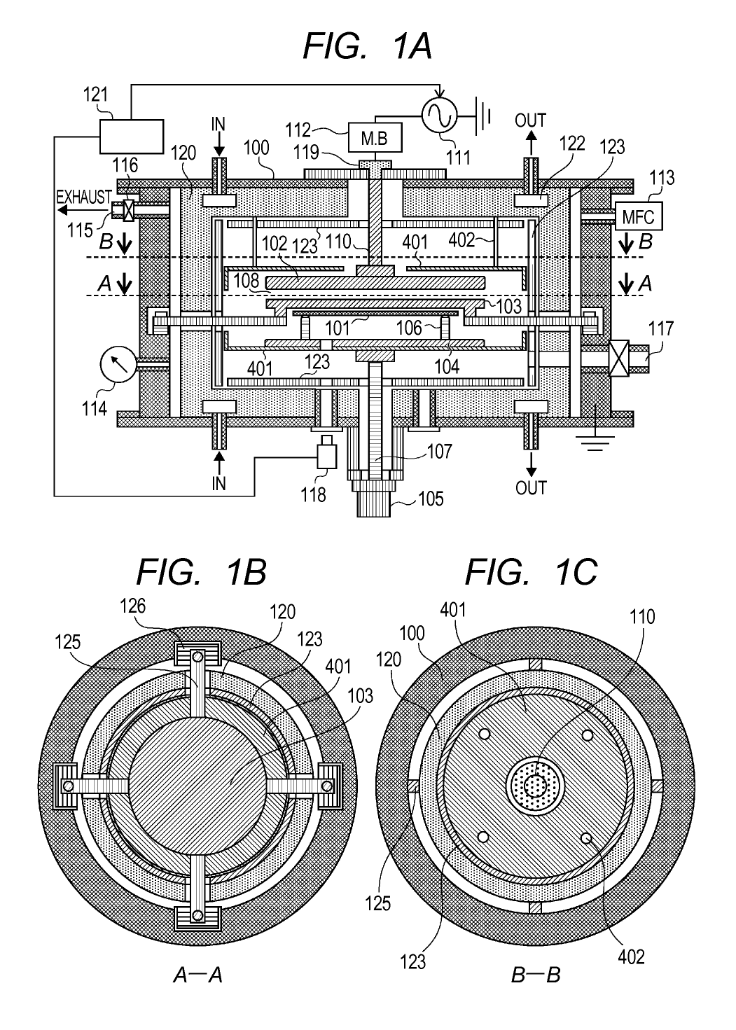

A heat treatment apparatus according to this embodiment will be described with reference to FIGS. 1A to 5. There can be provided the heat treatment apparatus that indirectly heats a specimen to be heated by plasma with the results that the heat treatment apparatus is high in thermal efficiency, can reduce a surface roughness of a substrate to be treated, and is excellent in a long-term stability even when the specimen to be heated is heated at 1200° C. or higher. Plasma generated between parallel plate electrodes is used as a heating source, and the electrodes are covered with a radiation reflecting mirror, as a result of which high-temperature heating is enabled with a device configuration of a low heat capacity, and the thermal efficiency can be enhanced. Further, a substrate to be treated is arranged through an upper electrode or a lower electrode so that the substrate to be treated does not come into direct contact with the plasma, thereby being capable of reducing the surface roughness of the substrate to be treated. However, in this configuration, it is found that a sufficient long-term stability is not obtained.

A factor for detracting the long-term stability will be first described. The above configuration has a structure in which, in order to obtain a high thermal efficiency, facing carbon electrodes (upper electrode, lower electrode) are covered with a radiation reflecting mirror having a high reflectance. A high-purity He atmosphere is used as an atmosphere in which electric discharge is formed. However, because of a high temperature process, the supply of He gas into the heat treatment chamber stops, or a slight amount of He gas flows into the heat treatment chamber during a heat treatment. Carbon electrodes which are a material of the upper electrode and the lower electrode contain hydrogen, oxygen, or moisture therein, and those gases are emitted from the electrodes in an initial stage of heating. When the gas is emitted, the gases are emitted in the form of carbon hydride, carbon monoxide, and hydrogen, and those emitted gases repeat disassociation and synthesis in the plasma, resulting in a risk that a sooty foreign matter may be formed. When the sooty foreign matter is attached to the radiation reflecting mirror, the reflectance is lowered, resulting in a risk that the heating efficiency is lowered. Under the circumstance, subsequently, a configuration for suppressing or preventing the above factor will be described.

A basic configuration of the heat treatment apparatus according to this embodiment will be described with reference to FIGS. 1A to 1C.

The heat treatment apparatus according to this embodiment includes a heat treatment chamber 100 that indirectly heats a specimen 101 to be heated (substrate to be treated) through a lower electrode 103 by the aid of plasma.

The heat treatment chamber 100 includes an upper electrode 102, the lower electrode 103 that is a heating plate facing the upper electrode 102, a stage 104 having support pins 106 which support the specimen 101 to be heated, a reflecting mirror (first radiation heat suppression member) 120 that reflects a radiation heat, a radio-frequency power supply 111 that supplies a radio-frequency power for plasma generation to the upper electrode 102, gas introducing means 113 for supplying a gas into the heat treatment chamber 100, and a vacuum valve 116 that adjusts a pressure within the heat treatment chamber 100. A power from the radio-frequency power supply can be supplied to the lower electrode 103 which is the heating plate together with the upper electrode, or instead of the upper electrode.

The specimen 101 to be heated is supported on the support pins 106 of the stage 104, and arranged closely below the lower electrode (heating plate) 103. Also, the lower electrode 103 is held by a side wall portion of the heat treatment chamber 100, and comes out of contact with the reflecting mirror 120, the specimen 101 to be heated, and the stage 104. In this embodiment, an SiC substrate of 4 inches (φ100 mm) is used as the specimen 101 to be heated. A diameter and a thickness of the upper electrode 102 and the stage 104 are set to 120 mm and 5 mm, respectively.

The upper electrode 102, the lower electrode 103, and the stage 104 within the heat treatment chamber 100 are structured to be surrounded by the reflecting mirror 120. The reflecting mirror 120 is configured by optically polishing an inner wall surface of a metal base material, and plating or evaporating gold on the polished surface. Also, a cooling passage 122 is formed in the metal base material of the reflecting mirror 120, and cooling water is allowed to flow into the cooling passage 122 to keep a constant temperature of the reflecting mirror 120. The reflecting mirror 120 is not an essential configuration, but can enhance the thermal efficiency because the radiation heat from the lower electrode 103 and the stage 104 are reflected by the reflecting mirror 120.

Also, protective quartz plates 123 are arranged between each of the upper electrode 102 and the stage 104, and the reflecting mirror 120. The protective quartz plates 123 have functions of preventing contamination on surfaces of the reflecting mirror 120 by emissions (sublimation of graphite) from the upper electrode 102, the lower electrode 103, and the stage 104 which are at 1200° C. or higher, and preventing contamination likely to be mixed into the specimen 101 to be heated from the reflecting mirror 120.

A diameter of the lower electrode 103 is the same as that of the upper electrode, and leading ends of beams that support the lower electrode 103 extend to an interior of the side wall portion of the heat treatment chamber 100, and a thickness of the lower electrode 103 including the beams is set to 2 mm. Also, the lower electrode 103 has an inner cylindrical member configured to cover the side surface of the specimen 101 to be heated on an opposite side of a surface facing the upper electrode 102. Top views of a cross-section A and a cross-section B indicated in FIG. 1A are illustrated in FIGS. 1B and 1C, respectively. As illustrated in FIG. 1B, the lower electrode 103 includes a disc-shaped member substantially identical in diameter with the upper electrode 102, and four beams arranged at regular intervals so as to connect the above disc-shaped member to the side wall portion of the heat treatment chamber 100. The number, the cross-sectional area, and the thickness of the above beams can be determined taking a strength of the lower electrode 103, and the radiation from the lower electrode 103 toward the heat treatment chamber 100 into account.

Heat shields (plate material high in melting point and low in radiation factor, or coating high in melting point and low in radiation factor: second radiation heat suppression member) 401 are arranged in an intermediate position between the reflecting mirror (first radiation heat suppression member) 120, and each of the upper electrode 102, the lower electrode 103, the specimen 101 to be heated, and the stage 104 so as to surround the upper electrode 102, the lower electrode 103, the specimen 101 to be heated, and the stage 104. The heat shields 401 are divided into an upper portion and a lower portion, and the upper heat shield 401 are fixed to the reflecting mirror 120 by fixing parts 402, and the lower heat shield 401 is fixed to the stage 104. The fixing parts 402 that fix the upper heat shield are each formed of a thin stick-like member made of quartz or ceramic. A material of the fixing parts 402 is selected from a material having a thermal conductivity as low as possible, and set to a minimum size necessary to fix the heat shields 401 to keep a heat transfer loss from the heat shields 401 to the reflecting mirror 120 low. Also, in this embodiment, the heat shields 401 are each formed of a tungsten foil 0.1 mm in thickness. In this embodiment, the heat shields 401 each have an end side wall in a peripheral portion thereof. The end side wall is not essential, but provided to more enhance the thermal efficiency. The end side walls may be formed integrally with heat shield main bodies, but can be machined separately from the heat shield main bodies and coupled together. The heat shields 401 according to this embodiment each have no portion directly contacting with members (upper electrode 102 and lower electrode 103) heated directly by the plasma, and are distant from all of those members. As a result, because a heating temperature of the heat shields can be reduced, a long-term deterioration of the radiation factor, and the emission of impurities attributable to thermal deterioration can be suppressed. Also, because the heat shields are arranged to surround the upper electrode and the lower electrode which become at a high temperature, even if the sooty foreign matter attributable to those electrodes is produced, the sooty foreign matter is inhibited and prevented from going around the surface side of the heat shields, and the sooty foreign matter can be inhibited and prevented from being attached onto the surfaces of the heat shields, and the surface of the reflecting mirror. As a result, a long-term reduction in the radiation factor of the heat shields, and a reduction in the reflectance of the reflecting mirror can be suppressed (the details will be described later).

Because the lower electrode 103 are held by side walls of the heat treatment chamber 100 through the thin beams as illustrated in FIGS. 1B and 1C, a heat of the lower electrode 103 heated by the plasma can be inhibited from being transferred to the side wall of the heat treatment chamber 100, as a result of which the lower electrode 103 functions as the heating plate high in the thermal efficiency. The plasma generated between the upper electrode 102 and the lower electrode 103 is diffused from spaces between the respective beams toward the vacuum valve 116 side. However, because the specimen 101 to be heated is covered with the above-mentioned inner cylindrical member, the specimen 101 to be heated is not exposed to the plasma.

Also, the upper electrode 102, the lower electrode 103, the stage 104, and the support pins 106 are each obtained by depositing SiC on a surface of a graphite base material through a chemical vapor deposition (hereinafter referred to as “CVD technique”).

Also, a gap formed between the lower electrode 103 and the upper electrode 102 is set to 0.8 mm. The specimen 101 to be heated has a thickness of about 0.5 mm to 0.8 mm, and circumferential corner portions of the respective facing sides of the upper electrode 102 and the lower electrode 103 are tapered or rounded. This is because the plasma localization on the respective corner portions of the upper electrode 102 and the lower electrode 103 due to the concentration of an electric field is suppressed.

The stage 104 is connected to a lifting mechanism 105 through a shaft 107, and the lifting mechanism 105 is operated to enable the specimen 101 to be heated to be delivered, and the specimen 101 to be heated to come closer to the lower electrode 103. The details will be described later. Also, the shaft 107 is made of an alumina material.

The radio-frequency power is supplied to the upper electrode 102 from the radio-frequency power supply 111 through an upper feed line 110. In this embodiment, a frequency of the radio-frequency power supply 111 is 13.56 MHz. The lower electrode 103 is electrically connected to the reflecting mirror 120 through the beams. Further, the lower electrode 103 is grounded through the reflecting mirror 120. The upper feed line 110 is also made of graphite which is a construction material of the upper electrode 102 and the lower electrode 103.

A matching circuit 112 (M.B in FIG. 8 is an abbreviation for matching box) is arranged between the radio-frequency power supply 111 and the upper electrode 102, and the radio-frequency power from the radio-frequency power supply 111 is efficiently supplied to a plasma 124 formed between the upper electrode 102 and the lower electrode 103.

The gas can be introduced in a range of from 0.1 atmospheric pressure to 10 atmospheric pressure into the heat treatment chamber 100 in which the upper electrode 102 and the lower electrode 103 are arranged, by the gas introducing means 113. A pressure of the introduced gas is monitored by pressure detecting means 114. Also, the heat treatment chamber 100 can exhaust gas by the aid of a vacuum pump connected to an exhaust port 115 and the vacuum valve 116.

Subsequently, a basic operation example of the heat treatment apparatus according to this embodiment will be described.

First, an He gas within the heat treatment chamber 100 is exhausted from the exhaust port 115 into a high vacuum state. In a stage where the sufficient gas exhaust has been finished, the exhaust port 115 is closed, the gas is introduced by the gas introducing means 113, and the interior of the heat treatment chamber 100 is controlled to 0.6 atmospheric pressure. In this embodiment, the gas introduced into the heat treatment chamber 100 is He.

The specimen 101 to be heated preheated in a spare chamber (not shown) at 400° C. is transported from a transport port 117, and is supported on the support pins 106 of the stage 104. The detail of a support method of the specimen 101 to be heated on the support pins 106 will be described later.

After the specimen 101 to be heated has been supported on the support pins 106 of the stage 104, the stage 104 is lifted up to a given position by the aid of the lifting mechanism 105. In this embodiment, the given position is set to a position where a distance between a lower surface of the lower electrode 103 and the surface of the specimen 101 to be heated is 0.5 mm.

In this embodiment, the distance between the lower surface of the lower electrode 103 and the surface of the specimen 101 to be heated is set to 0.5 mm, but may be set in a range of from 0.1 mm to 2 mm. The thermal efficiency becomes higher as the specimen 101 to be heated comes closer to the lower surface of the lower electrode 103. However, a risk that the lower electrode 103 and the specimen 101 to be heated come into contact with each other becomes higher, or a problem on contamination more occurs as the specimen 101 to be heated comes closer to the lower surface of the lower electrode 103. Therefore, it is not preferable that the above distance is lower than 0.1 mm. Also, it is not preferable that the distance is larger than 2 mm, because the heating efficiency is lowered, and the radio-frequency power necessary for heating becomes large. For that reason, the proximity in this embodiment is set to the distance of from 0.1 mm to 2 mm.

After the stage 104 has been lifted to the given position, the radio-frequency power from the radio-frequency power supply 111 is supplied to the upper electrode 102 through the matching circuit 112 and a power introduction terminal 119, and the plasma is generated within a gap 108 to heat the specimen 101 to be heated through the lower electrode 103. An energy of the radio-frequency power is absorbed by electrons within the plasma, and atoms or molecules of a raw gas are heated by collision of the electrons. Also, ions generated by ionization are accelerated by a potential difference generated in a sheath on the surfaces of the upper electrode 102 and the lower electrode 103 which come into contact with the plasma, and are input to the upper electrode 102 and the lower electrode 103 while colliding with the raw gas. Through the above collision process, the temperature of the gas filled between the upper electrode 102 and the lower electrode 103, and the temperatures of the surfaces of the upper electrode 102 and the lower electrode 103 can be raised.

In particular, in the almost atmospheric pressure as in this embodiment, since the ions frequently collide with the raw gas when passing through the sheath, it is conceivable that the raw gas filled between the upper electrode 102 and the lower electrode 103 can be efficiently heated. In this example, the almost atmospheric pressure represents a pressure ranging from 0.1 atmospheric pressure to 1 atmosphere. As a result, the temperature of the raw gas can be easily heated up to about 1200 to 2000° C. The upper electrode 102 and the lower electrode 103 are heated by bringing the heated high-temperature gas into contact with the upper electrode 102 and the lower electrode 103. Also, a part of a neutral gas excited by the electron collision is deexcited with light emission, and the upper electrode 102 and the lower electrode 103 are also heated by the light emission in this situation. Further, the stage 104 and the specimen 101 to be heated are heated by going-around of the high-temperature gas, and the radiation from the upper electrode 102 and the lower electrode 103 which have been heated.

In this example, since the lower electrode 103 that is the heating plate is disposed closely above the specimen 101 to be heated, the specimen 101 to be heated is heated after the lower electrode 103 has been heated by the gas heated at a high temperature by the aid of the plasma, to thereby obtain an advantage that the specimen 101 to be heated is evenly heated. Also, with the provision of the stage 104 below the lower electrode 103, an even electric field is formed between the lower electrode 103 and the upper electrode 102 regardless of a configuration of the specimen 101 to be heated regardless of a shape of the specimen 101 to be heated, thereby enabling the uniform plasma to be generated. Further, the specimen 101 to be heated is arranged below the lower electrode 103, as a result of which the specimen 101 to be heated is not exposed directly to the plasma formed in the gap 108. Also, even when the discharge transitions from a glow discharge to an arc discharge, a discharge current flows into the lower electrode 103 without passing through the specimen 101 to be heated. As a result, the specimen 101 to be heated can be prevented from being damaged.

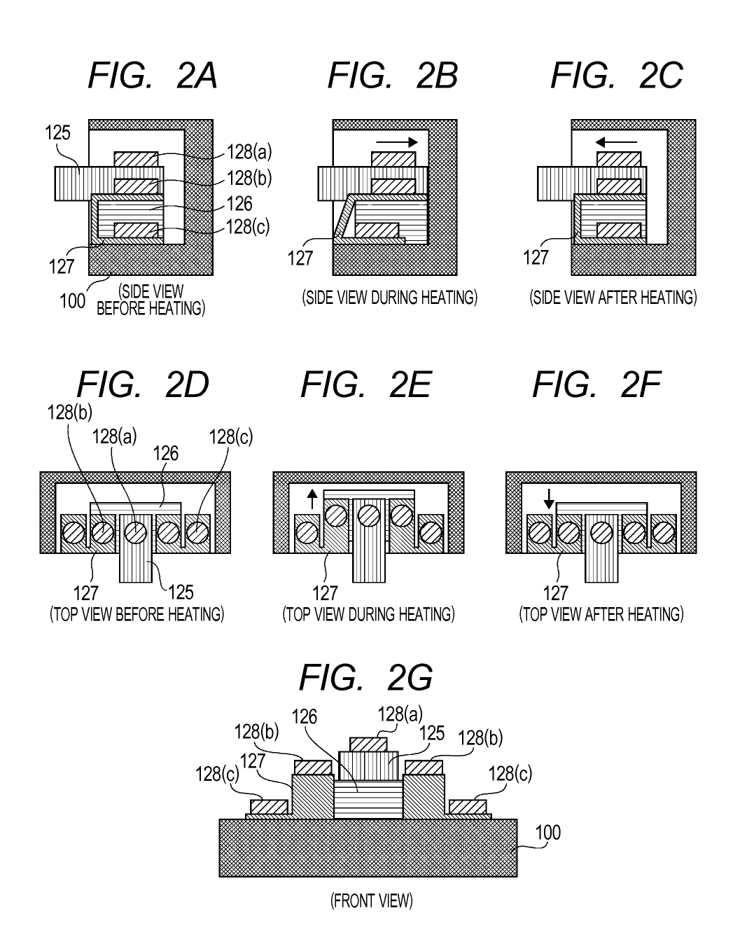

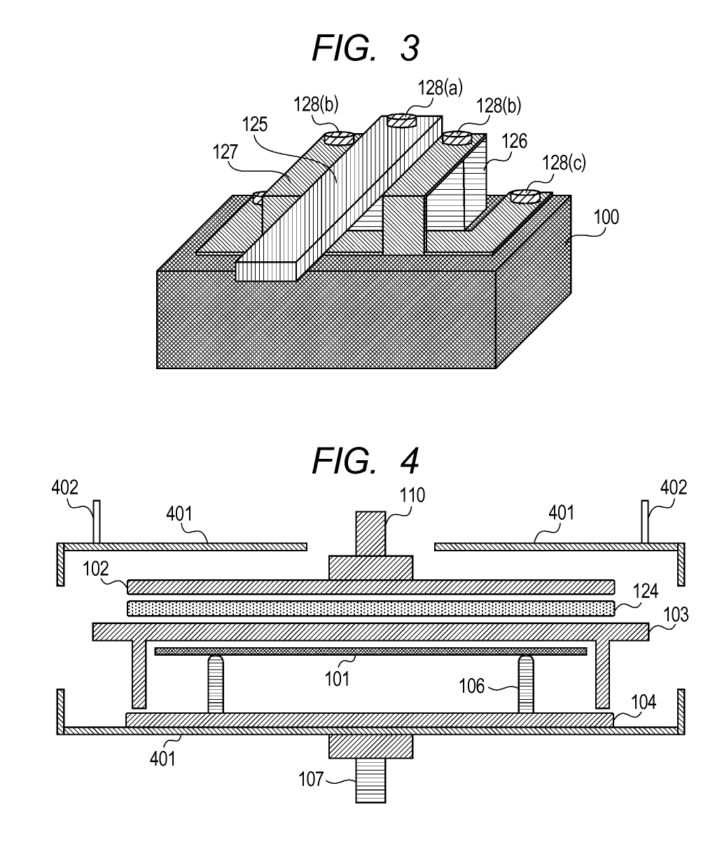

Subsequently, the details of a conduction portion from beams 125 to the heat treatment chamber 100 will be described with reference to FIGS. 2A to 2G, and 3. Each of the beams 125 is fixed to a relay block (base) 126 by a bolt 128(a), and the relay block 126 is fixed to elastic materials (flat springs) 127 by bolts 128(b). The elastic materials (flat springs) 127 are fixed to the heat treatment chamber 100 by bolts 128(c) (FIGS. 2G and 3). That is, the beam 125 is grounded to the heat treatment chamber 100 through the relay block 126 and the elastic materials (flat springs) 127. Because the beam 125, the relay block 126, the elastic materials (flat springs) 127, and the heat treatment chamber 100 are fixed to each other by the bolts 128, a sufficient conduction can be obtained.

Subsequently, the motion of the ground portions of the beam 125 and the heat treatment chamber 100 will be described before heating, during heating, and after heating.

As illustrated in FIGS. 2A and 2D, before heating, the beam 125, the relay block 126, and the elastic materials (flat springs) 127 on a side which is fastened to the relay block wait in a front space within the heat treatment chamber 100.

During heating, when the temperature of the lower electrode 103 having a diameter 200 mm rises to 2000° C., the lower electrode 103 is thermally expanded by about 2 mm in a radial direction. The thermal expansion of the lower electrode 103 is absorbed by deformation of the elastic materials (flat springs) 127 (FIGS. 2B and 2E). During heating, when the lower electrode 103 is thermally expanded, a force is applied to move the beam 125 and the relay block 126 fastened to the beam 125 backward. Therefore, the elastic materials (flat springs) 127 is deformed, and the beam 125, the relay block 126, and the elastic materials (flat springs) 127 on the side fastened to the relay block 126 move toward a rear space within the heat treatment chamber 100.

After heating, because the lower electrode 103 is going to be returned to a state before the lower electrode 103 is thermally expanded while the lower electrode 103 is cooled, a force is applied to return the beam 125 and the relay block 126 forward. Thereafter, because the elastic materials (flat springs) is going to be returned to an original shape, the beam 125, the relay block 126, and the elastic materials (flat springs) 127 on the side fastened to the relay block 126 move to the front space within the heat treatment chamber 100, and return to a state before heating (FIGS. 2C and 2F).

In this embodiment, the elastic materials (flat springs) 127, the relay block 126, and the bolts 128 are made of a stainless material which is inexpensive and relatively high in melting point, but may be made of a metal with a high melting point such as tungsten, tantalum, molybdenum, or niobium. Also, thermal expansion absorption member having the elastic material is not limited to a heat treatment using the plasma, but can be used when an excellent electric conduction between a member that thermally expands at a high temperature, and a member smaller in the thermal expansion because of a lower temperature than that temperature is required.

Also, when the upper electrode 102 and the lower electrode 103 are heated by the aid of the plasma, there is a risk that a sooty foreign matter is formed between the upper electrode 102 and the lower electrode 103 due to the sublimation of the electrode member. The sooty foreign matter is carried by an air current of the heat treatment chamber 100 attributable to heating, and stuck onto the protective quartz plates 123 of the reflecting mirror 120. When the sooty foreign matter is stuck onto the protective quartz plates 123, an effective reflectance of the reflecting mirror 120 is reduced to lead to a reduction in the heating efficiency of the upper electrode 102 and the lower electrode 103, and a temporal change thereof. This causes the stable and high-efficient heat treatment of the specimen 101 to be heated to be inhibited. However, in this embodiment, the heat shields (plate material high in melting point and low in radiation factor, or coating high in melting point and low in radiation factor) 401 is arranged in the intermediate position between the heating region (upper electrode 102, the lower electrode 103, the specimen 101 to be heated, and the stage 104), and the reflecting mirror 120. For that reason, even if the sooty foreign matter is produced in the plasma, the sooty foreign matter is stuck to the inner surfaces (surfaces facing the upper electrode 102, the lower electrode 103, the specimen 101 to be heated, and the lower electrode 103) of the heat shields 401 so that the sooty foreign matter can be prevented from being stuck to the reflecting mirror 120 surface and the outer side surfaces (surfaces facing the reflecting mirror) of the heat shields 401. The heating efficiency of the heating region (upper electrode 102, the lower electrode 103, the specimen 101 to be heated, and the stage 104) is determined according to the radiation factors of the reflecting mirror 120 surface, and the outer side surfaces (surfaces facing the reflecting mirror) of the heat shields. Therefore, even if the sooty foreign matter is stuck onto the inner surfaces (surfaces facing the upper electrode 102, the lower electrode 103, the specimen 101 to be heated, and the stage 104) of the heat shields 401 to change the radiation factor, the radiation factor is not largely changed. Hence, the thermal efficiency of the heating region can be stably held over a long term.

When the heat shields 401 are installed, the heating region represents a heating region inside of the heat shields 401 including the heat shields 401. Hence, the heat capacity of the heating portion also includes the heat capacity of the heat shields 401. However, as described in this embodiment, when the heat shields 401 are each formed of a tungsten member as thin as about 0.1 mm, the heat capacity of the heat shields 401 portion can be extremely reduced, and a degradation in a temperature response attributable to an increase in the heat capacity can be minimized. That is, the thermal capacity of the heat treatment chamber 100 can be controlled by a volume formed by the heat shields 401. Also, as described above, even if the sooty foreign matter is stuck onto the inner surfaces of the heat shields 401 to change the radiation factor, this hardly affects the heating efficiency of the overall heating region (the upper electrode 102, the lower electrode 103, the specimen 101 to be heated, and the stage 104 arranged inside of the heat shields 401) including the heat shields 401. Strictly speaking, the thermal response inside of the heat shields 401 is changed by the heat capacity of the heat shields 401. However, if the heat capacity of the heat shields 401 is set to be extremely lower than the heat capacity of the overall heating region (the heat shields 401, the upper electrode 102, the lower electrode 103, the specimen 101 to be heated, and the stage 104), an influence of the change in the thermal response can be ignored. However, if the radiation factor of the inner surface of the heat shields 401 is set to be high the first time, the change due to the attachment of soot can be relatively reduced, and the temporal change of the heating response due to the attachment of the sooty foreign matter can be further reduced. Specifically, the outer surfaces of the heat shields 401 are polished to reduce the radiation factor, but the inner surface thereof is not polished, thereby being capable of obtaining the above advantages.

The temperature of the heat shields 401 is an intermediate temperature between the temperature of the upper electrode 102 and the lower electrode 103, and the temperature of the protective quartz plates 123 of the cooled reflecting mirror 120. Specifically, when the temperature of the upper electrode 102 and the lower electrode 103 are 1800° C., because the protective quartz plates 123 comes closer to the cooled reflecting mirror, the temperature of the protective quartz plates 123 becomes about 100° C. When the heat shields 401 are arranged just in the intermediate position therebetween, the temperature of the heat shields 401 becomes about 1000° C. which is a mean of 1800° C. and 200° C. When the heat shields 401 comes closer to the upper electrode 102 and the lower electrode 103 side, the temperature of the heat shields 401 comes closer to the temperature of the upper electrode 102 and the lower electrode 103. Conversely, when the heat shields 401 come closer to the protective quartz plates 123, the temperature comes closer to the temperature of the protective quartz plates 123. In this embodiment, when the temperature of the upper electrode 102 and the lower electrode 103 is 1800° C., the heat shields 401 are arranged at a position where the temperature of the heat shields 401 becomes about 1400° C. When the temperature of the heat shields 401 is maintained at a low value as compared with the temperature of the upper electrode 102 and the lower electrode 103, which is necessary for the heat treatment, thereby being capable of preventing a change in quality and the emission of a contaminated material attributable to the high temperature of the material of the heat shields 401. When the heat shields 401 is maintained at about 1800° C. which is a treatment temperature, this causes a change in the quality caused by recrystallization of tungsten which is a material of the heat shields 401, and the emission of a small amount of impurities contained within the heat shields 401. Also, when the heat shields 401 come into direct contact with the plasma, this increases a risk of the emission of the contaminated material from the heat shields 401, and the change in the material quality. Hence, the heat shields illustrated in FIG. 1A are distant from the upper electrode 102 and the lower electrode 103, and arranged between each of the upper electrode 102 and the lower electrode 103, and the reflecting mirror 120, thereby being capable of suppressing the change in the radiation factor of the heat shields 401, and the emission of the contaminated material.

If it is assumed that the radiation factor of the outer surfaces (surfaces facing the reflecting mirror 120) of the heat shields 401 illustrated in FIG. 1A is ∈ₛ, and the radiation factor of the reflecting mirror 120 is ∈ₘ, a radiation loss T_{Loss} of the heating region (the heat shields 401, the upper electrode 102, the lower electrode 103, the specimen 101 to be heated, and the stage 104) in the configuration of FIG. 1 is represented by Expression (1).

$${T}_{Loss} ∝ \frac{1}{\frac{1}{{ɛ}_{s}} + \frac{1}{{ɛ}_{m }} - 1} \qquad ( 1 )$$

As understood from Expression (1), it is found that the radiation loss T_{Loss} of the heating region becomes smaller as both of the radiation factors ∈ₛ and ∈ₘ are smaller, and the thermal efficiency can be enhanced. When the reflecting mirror 120 uses a mirror surface of gold (Au), the radiation factor ∈ₛ can be set to be equal to or lower than 0.1. On the other hand, because the heat shields must suppress the contamination as much as possible while withstanding a certain level of high temperature, the option of the material of the heat shields is limited. In this embodiment, the tungsten foils are used as the heat shields, and at least the outer surfaces (surfaces facing the reflecting mirror 120) of the tungsten foils are polished as polished surfaces, thereby capable of setting the radiation factor ∈ₘ to about 0.1 to 0.5. For example, the heat loss of the heating region when only the reflecting mirror 120 is used without the use of the heat shields (plate material high in melting point and low in radiation factor, or coating high in melting point and low in radiation factor) 401 is a loss suppression of about 1/9 (when the radiation factor of the reflecting mirror 120 is 0.1, and the radiation factor of the upper electrode and the lower electrode is 1) of a case using no reflecting mirror. However, when the heat shields 401 are installed, and the radiation factor of the outer surfaces (surfaces facing the reflecting mirror 120) of the tungsten is finished to about 0.1, the radiation loss is 1/19, and can substantially halve the heat loss in the heating region as compared with a case of only the reflecting mirror 120. Thus, the heating efficiency can be enhanced.

In order to efficiently raise the temperatures of the upper electrode 102, the lower electrode 103, and the stage 104 (including the specimen 101 to be heated), there is a need to suppress the heat transfer of the upper feed line 110, the heat transfer through the He gas atmosphere, and the radiation (range from infrared rays to visual light) from a high temperature range. In particular, in a high temperature state of 1200° C. or higher, an influence of the heat loss due to the radiation is very large, and a reduction in the radiation loss is essential for an improvement in the heating efficiency. The radiation loss increases the amount of radiation with the fourth power of an absolute temperature. Hence, with the use of the reflecting mirror 120 and the heat shields 401 described above, the thermal efficiency of the heating region can be remarkably improved.

The temperature of the lower electrode 103 or the stage 104 during the heat treatment is measured by a radiation thermometer 118, and an output of the radio-frequency power supply 111 is controlled so that the above temperature reaches a given temperature by a control device 121 with the use of a measured value. Therefore, the temperature of the specimen 101 to be heated can be controlled with a high precision. In this embodiment, the radio-frequency power to be input is set to 20 kW at the maximum.

Also, the plasma of the heating source is set as plasma in a grow discharge region so that the plasma evenly spread can be formed between the upper electrode 102 and the lower electrode 103, and the specimen 101 to be heated is heated with the even and planar plasma as a heat source so that the planar specimen 101 to be heated can be evenly heated.

Also, since the specimen 101 to be heated can be evenly heated, even if the temperature is rapidly raised, a risk that the specimen 101 to be heated is damaged with an uneven temperature within the specimen 101 to be heated is low. From the above viewpoint, fast temperature rising and drop are enabled, and a time necessary for a series of heat treatment can be reduced. With this advantage, the throughput of the heat treatment is improved, a stay of the specimen 101 to be heated in a high-temperature atmosphere for a time more than necessary can be suppressed, and the SiC surface roughness associated with the high temperature can be reduced.

Upon completion of the above heat treatment, in a stage where the temperature of the specimen 101 to be heated falls below 800° C., the specimen 101 to be heated is carried out of the transport port 117, a subsequent specimen 101 to be heated is transported into the heat treatment chamber 100, and supported on the support pins 106 of the stage 104, and the operation of the above-mentioned heat treatment is repeated.

When the specimen 101 to be heated is replaced with another, a gas atmosphere at a retreat position (not shown) of a specimen to be heated which is connected to the transport port 117 is maintained at the same degree as that within the heat treatment chamber 100. As a result, the amount of gas to be used can be reduced without need to replace He within the heat treatment chamber 100 associated with the replacement of the specimen 101 to be heated.

Since the purity of the He gas within the heat treatment chamber 100 may be decreased to some extent by repeating the heat treatment, the replacement of the He gas is periodically implemented in this situation. When the He gas is used for the discharge gas, because the He gas is a relatively expensive gas, the used amount is reduced as much as possible to suppress the running costs. This is also applicable to the amount of He gas introduced during the heat treatment, and a minimum flow rate necessary to keep the gas purity during treatment is kept so that the used amount of gas can be reduced. Also, a cooling time of the specimen 101 to be heated can be reduced by the He gas introduction. That is, after the heat treatment has been completed (after electric discharged has been completed), the He gas flow rate is increased so that the cooling time can be more reduced due to the cooling effect of the He gas.

In the above description, the specimen 101 to be heated is carried out in a state of 800° C. or lower. On the other hand, when a transport arm high in heat resistance is used, even if the specimen 101 to be heated is at 800° C. to 2000° C., the specimen 101 to be heated can be carried out, and a wait time can be reduced.

In this embodiment, the gap 108 between the upper electrode 102 and the lower electrode 103 is set to 0.8 mm. however, the same effect is obtained even if the gap 108 ranges from 0.1 mm to 2 mm. Also, in the case of the gap narrower than 0.1 mm, the electric discharge is enabled, but a high-precision function is necessary for maintaining a parallelism between the upper electrode 102 and the lower electrode 103. Also, because a change in the quality (roughness, etc.) of the surfaces of the upper electrode 102 and the lower electrode 103 affects the plasma 124, the change in the quality is not preferable. On the other hand, if the gap 108 exceeds 2 mm, an ignition degradation of the plasma 124 and an increase in the radiation loss from the gap are problematic and not preferable.

In this embodiment, the pressure within the heat treatment chamber 100 for plasma generation is set to 0.6 atmospheric pressure. However, the same operation is enabled even under the atmospheric pressure of 10 atmospheric pressure or lower. If the pressure exceeds 10 atmospheric pressure, even glow discharge is difficult to generate.

In this embodiment, He gas is used in the raw gas for plasma generation. In addition, the same advantages are obtained even if a gas using an inert gas such as Ar, Xe, or Kr as a main raw material is used. The He gas used in this embodiment is excellent in the plasma ignition and stability under the substantially atmospheric pressure. However, the thermal conductivity of the gas is high, and the heat loss due to heat transfer through the gas atmosphere is relatively large. On the other hand, a gas large in mass such as Ar, Xe, or Kr gas is low in the thermal conductivity, and therefore superior to the He gas from the viewpoint of the thermal efficiency.

In this embodiment, the heat shields (plate material high in melting point and low in radiation factor, or coating high in melting point and low in radiation factor) 401 are made of tungsten. In addition, even if the heat shields 401 are made of WC (tungsten carbide), MoC (molybdenumcarbide), Ta (tantalum), Mo (molybdenum), or a graphite base material coated with TaC (tantalum carbide), the same advantages are obtained. Similarly, in this embodiment, the heat shields 401 are made of tungsten 0.1 mm in thickness. However, the same advantages are obtained even if a material of 1 mm or lower is used. A material thicker than 1 mm is not preferable because an increase in the heat capacity is relatively large, and the costs are also increased.

In this embodiment, opposite sides of the surfaces of the upper electrode 102, the lower electrode 103, and the stage 104 which come into contact with the plasma are made of graphite coated with silicon carbide through the CVD technique. In addition, the same advantages are obtained even if a graphite single body, a member made of graphite coated with pyrolized carbon, a member having a graphite surface virified, and SiC (sintered body, polycrystal, single crystal) are used. It is needless to say that graphite which is the base material of the upper electrode 102 and the lower electrode 103, and coating on the surface thereof are desirably high pure from the viewpoint of preventing the specimen 101 to be heated from being contaminated.

Also, during the heat treatment at 1200° C. or higher, a contamination of the specimen 101 to be heated from the upper feed line 110 may be influenced. Hence, in this embodiment, the heat treatment chamber 100 is also made of the same graphite as that of the upper electrode 102 and the lower electrode 103. Also, the heat of the upper electrode 102 is transferred through the upper feed line 110, and lost. Hence, the heat transfer from the upper feed line 110 needs to be minimized.

Hence, a cross-section of the upper feed line 110 made of graphite needs to be as small as possible, and a length thereof needs to be longer. However, when the cross-section of the upper feed line 110 is extremely reduced, and the length thereof is too lengthened, the radio-frequency power loss in the upper feed line 110 becomes large, and the heating efficiency of the specimen 101 to be heated is lowered. For that reason, in this embodiment, from the above viewpoints, the cross-section of the upper feed line 110 made of graphite is set to 12 mm², and the length thereof is set to 40 mm. The same advantages are obtained even if the cross-section of the upper feed line 110 ranges from 5 mm² to 30 mm², and the length of the upper feed line 110 ranges from 30 mm to 100 mm.

Further, the heat of the stage 104 is transferred through the shaft 107, and lost. Hence, the heat transfer from the shaft 107 also needs to be minimized as with the above upper feed line 110. Hence, a cross-section of the shaft 107 made of alumina material needs to be as small as possible, and a length thereof needs to be longer. In this embodiment, taking the strength into account, the cross-section and the length of the shaft 107 made of alumina material are identical with those in the above upper feed line 110.

In this embodiment, the radiation loss from each of the upper electrode 102, the lower electrode 103, and the stage 104 is reduced by the heat shields 401, and the radiation light is returned to the heat shields 401 by the reflecting mirror 120, to thereby improve the heating efficiency. However, even if only the heat shields 401 are formed around the upper electrode 102, the lower electrode 103, and the stage 104, an improvement in the heating efficiency can be expected. Likewise, even if only the reflecting mirror 120 is located, an improvement in the heating efficiency can be expected. Further, the protective quartz plates 123 are installed for the purpose of expecting the effect of the contamination prevention. Even if the protective quartz plates 123 are not used, a sufficient heating efficiency can be obtained.

In this embodiment, the heat release from the upper electrode 102, the lower electrode 103, and the stage 104, which affects the heating efficiency as described above mainly includes (1) radiation, (2) heat transfer of gas atmosphere, and (3) heat transfer from the upper feed line 110 and the shaft 107. When the heat treatment is conducted at 1200° C. or higher, a main factor of the heat release largest among those factors is (1) radiation. In order to suppress the radiation of (1), the reflecting mirror 120 and the heat shields 401 are provided. Also, the heat release from the upper feed line 110 and the shaft 107 of (3) is minimized by optimizing the cross-sections and the lengths of the upper feed line 110 and the shaft 107 as described above.

In this embodiment, the radio-frequency power supply of 13.56 MHz is used for the radio-frequency power supply 111 for the plasma generation. This is because since 13.56 MHz is an industrial frequency, a power supply is available at low costs, and a standard for electromagnetic wave leakage is also low, thereby being capable of reducing the device costs. However, in principle, it is needless to say that the heat treatment can be conducted at another frequency in the same principle. In particular, a frequency of 1 MHz or higher and 100 MHz or lower is preferable. When the frequency is lower than 1 MHz, a radio-frequency voltage when supplying an electric power necessary for the heat treatment becomes high, an abnormal discharge (unstable plasma or electric discharge except for the gap between the upper electrode and the lower electrode) is generated, thereby making it difficult to generate stable plasma.

Also, in a frequency exceeding 100 MHz, an impedance in the gap 108 between the upper electrode 102 and the lower electrode 103 is low, thereby making it difficult to obtain a voltage necessary for the plasma generation. Therefore, such a frequency is not desirable.

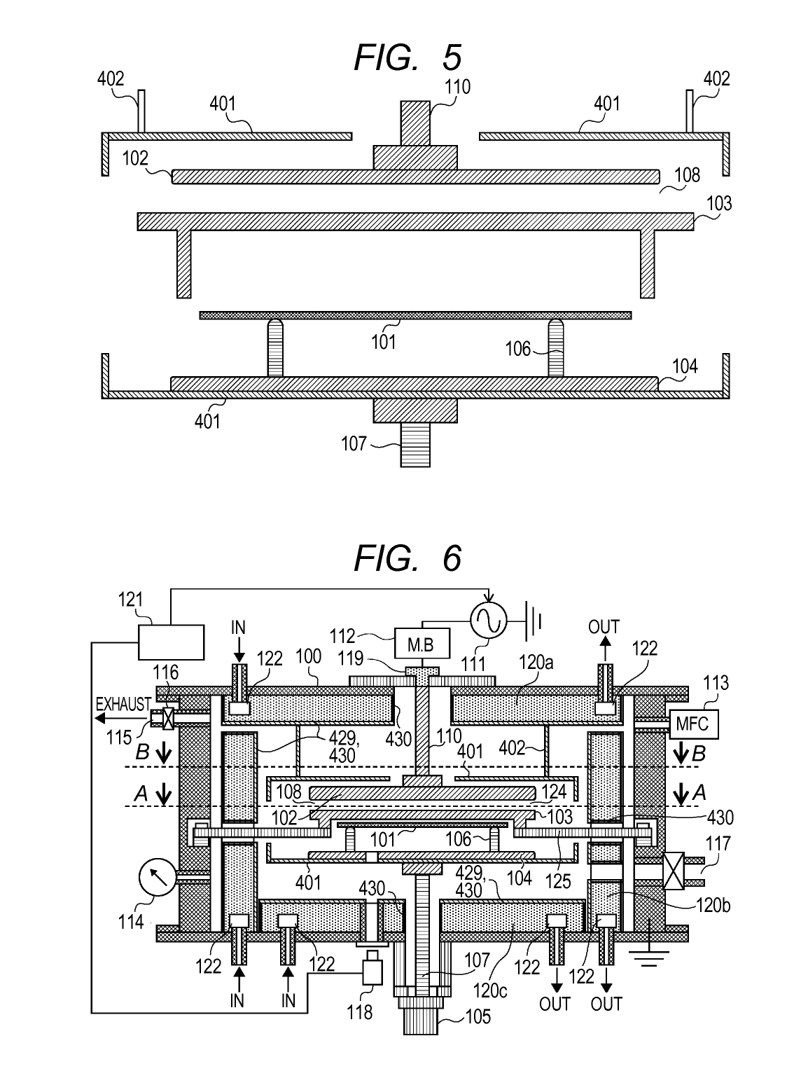

Subsequently, a method of carrying the specimen 101 to be heated in or out of the heat treatment chamber 100 will be described with reference to FIGS. 4 and 5. FIGS. 4 and 5 are diagrams illustrating details of the heating region of the heat treatment chamber 100. FIG. 4 illustrates a state during the heat treatment, and FIG. 5 illustrates a state when carrying in or out of the specimen 101 to be heated.

When the specimen 101 to be heated supported on the support pins 106 of the stage 104 is carried out, the plasma 124 stops from a heat treatment state of FIG. 4, and the position of the stage 104 moves down through the shaft 107 by the lifting mechanism 105. With this operation, as illustrated in FIG. 5, an end portion between the specimen 101 to be heated and the stage 104 having a gap is opened. A transport arm (not shown) is inserted into the gap in parallel from the transport port 117, and the lifting mechanism 105 moves down whereby the specimen 101 to be heated can be delivered to the transport arm, and carried out. Also, when the specimen 101 to be heated is carried in the heat treatment chamber 100, the reverse operation of the above-mentioned carry-out of the specimen to be heated is conducted whereby the specimen 101 to be heated can be carried into the heat treatment chamber 100.

In a state where the support pins 106 of the stage 104 is moved down by the lifting mechanism 105, the specimen 101 to be heated is transported onto the support pins 106 by the transport arm (not shown) on which the specimen 101 to be heated is mounted. Thereafter, the stage 104 is lifted by the lifting mechanism 105, and the stage 104 receives the specimen 101 to be heated from the transport arm. After the transport arm has been pulled out, the stage 104 further moves up to a given position for subjecting the stage 104 to heat treatment whereby the specimen 101 to be heated can come closer to a lower portion of the lower electrode 103 which is the heating plate.

Also, in this embodiment, since the upper electrode 102 and the lower electrode 103 are fixed, the gap 108 is not varied. For that reason, the stable plasma 124 can be generated for each heat treatment of the specimen 101 to be heated.

As a result of subjecting the ion-implanted SiC substrate to heat treatment for one minute with the use of the above-mentioned heat treatment apparatus at 1500° C. according to this embodiment, an excellent conductive characteristic can be obtained. Also, the SiC substrate surface is not roughened. Even if this processing is repetitively implemented, the deterioration of the thermal efficiency is hardly found. Also, the stable plasma can be generated to obtain the high productivity. From the viewpoint of the stable plasma generation, the reflecting mirror and the heat shields are not always necessary, but the treatment at a higher temperature is enabled.

Hereinafter, the advantages of this embodiment are summarized. In the heat treatment apparatus according to this embodiment, the specimen 101 to be heated is heated with the plasma generated in the narrow gap as an indirect heat source. From the viewpoint of the uniformity, it is desirable that the plasma is generated by an atmospheric pressure glow discharge. The following seven advantages indicated below which are not obtained in the related art are obtained with this heating principle.

A first advantage resides in the thermal efficiency. The gas in the gap 108 is extremely small in the heat capacity, and the plate material 401 high in the melting point and low in the radiation factor, or the coating 401 high in the melting point and low in the radiation factor is arranged for the upper electrode 102, the lower electrode 103, and the stage 104. As a result, the specimen 101 to be heated can be heated by a system extremely small in the heating loss associated with the radiation.

A second advantage resides in the heating response and the uniformity. Because the heat capacity of the heating portion is extremely small, rapid temperature rising and drop are enabled. Also, because the gas heating due to the glow discharge is used for the heating source, the planar and even heating is enabled by the spread of the glow discharge. Because the temperature uniformity is high, the device characteristic variation in a plane of the specimen 101 to be heated caused by the heat treatment can be suppressed. Also, a damage on the specimen 101 to be heated due to the thermal stress associated with a temperature difference in the plane of the specimen 101 to be heated when a rapid temperature rising is conducted can be also suppressed.

A third advantage resides in a reduction in consumable parts associated with the heat treatment. In this embodiment, the gas that comes in contact with the upper electrode 102 and the lower electrode 103 is directly heated. Therefore, the higher temperature region is limited to a member arranged extremely close to the upper electrode 102 and the lower electrode 103, and a temperature of the member is equal to that of the specimen 101 to be heated. Hence, a lifetime of the member is long, and a region of the replacement attributable to the component deterioration is also small.

A fourth advantage resides in the surface roughness suppression of the specimen 101 to be heated. In this embodiment, since temperature rising and temperature drop times can be shortened by the above-mentioned advantages, a time when the specimen 101 to be heated is exposed to a high temperature environment can be minimized. As a result, the surface roughness can be suppressed. Also, in this embodiment, the plasma 124 due to the atmospheric pressure glow discharge is used as the heating source. However, the specimen 101 to be heated is not exposed directly to the plasma 124. As a result, the formation and removal processes of the protective film which are conducted by another device different from the heat treatment apparatus become unnecessary, and the manufacture costs of the semiconductor device using the SiC substrate can be reduced.

A fifth embodiment resides in the simplification of carrying the specimen 101 to be heated in or out of the heat treatment chamber 100.

In this embodiment, with only the lifting mechanism operation of the stage 104, the specimen 101 to be heated can be delivered from the transport arm (not shown) to the stage 104, or the specimen 101 to be heated can be delivered from the stage 104 to the transport arm (not shown). Also, because a complicated mechanism for conducting the above delivery is not required, the number of components within the heat treatment chamber 100 can be reduced, and the device configuration can be simplified.

A sixth advantage resides in that with the configuration of FIGS. 1A to 1C in which the heat shields 401 are arranged between each of the upper electrode 102 and the lower electrode 103, and the reflecting mirror 120, an improvement in the heating efficiency, a long-term stabilization, and the prevention of contamination of the specimen 101 to be heated can be conducted while minimizing an increase in the heat capacity of the heating region.

A seventh characteristic resides in the generation of the stable plasma. In this embodiment, the beam 125, the relay block 126, and the elastic materials (flat springs) 127 are used for grounding from the lower electrode 103 to the heat treatment chamber 100. As a result, because the sufficient conduction can be obtained while absorbing the thermal expansion of the lower electrode 103, the stable plasma can be generated, and the device high in productivity can be provided. Also, there can be provided the device excellent in the electric conduction between the members different in the degree of thermal expansion even in the general heat treatment without limited to the plasma heat treatment. Also, the thermal expansion absorption member for that device can be provided.

As described above in the respective embodiments, the present invention is directed to the heat treatment apparatus that indirectly heats the specimen to be heated with the plasma as a heating source. Also, in other words, the present invention is directed to a heat treatment apparatus including a heat treatment chamber that conducts a heat treatment on the specimen to be heated, in which the heat treatment chamber includes a heating plate, an electrode facing the heating plate, and a radio-frequency power supply that supplies a radio-frequency power for the plasma generation to the electrode, in which the plasma is generated between the electrode and the heating plate, and the specimen to be heated is indirectly heated with the plasma generated between the electrode and the heating plate as the heating source. It is desirable that the plasma is generated by the glow discharge.

### Second Embodiment

As a result that the present inventors have studied, the annealing device disclosed in Japanese Unexamined Patent Application Publication No. 2012-59872 is an annealing apparatus using the plasma which is high in the thermal efficiency as compared with another heat treatment apparatus such as the resistance heating furnace. However, when heating at 1200° C. or higher is conducted, it is found that the annealing device suffers from the following problems.

A first problem resides in the thermal efficiency. When the heat treatment is conducted at 1200° C. or higher, the heat release is dominated by the radiation, and increases with the fourth power of the temperature. For that reason, the annealing device disclosed in Japanese Unexamined Patent Application Publication No. 2012-59872 suppresses the radiation loss with the use of the reflecting mirror for suppressing the radiation, and installs a protective quartz inside of the reflecting mirror as a protection countermeasure of the radiation factor, and a contamination countermeasure of the reflecting mirror.

However, fused quartz exhibits a high transmission of 80% or higher generally in a wavelength region (0.3 to 3.0 μm) from the visible light to the near infrared rays, but exhibits an optical characteristic that the transmission is remarkably lowered in a wavelength region (from about 3.0 μm) of a middle wavelength or longer. Also, in a region of a treatment temperature of 1200 to 1800° C., the radiation close to the wavelength region (0.75 to 3.0 μm) from the near infrared rays to the short-wavelength infrared rays becomes a major radiation. In the radiation of the wavelength of 3.0 μm or higher as an absolute amount, the radiation loss of quartz as a protective material cannot be also ignored from the viewpoints of the thermal efficiency.

Also, because the amount of radiation absorbed by quartz increases in proportion to the thickness of quartz, in the temperature region in which the radiation heat is major as the heat release, the thermal efficiency is remarkably lowered as quartz is thicker, and the input power necessary for the treatment temperature is increased.

Also, as another factor for lessening the thermal efficiency, because the electric discharge other than the gap between the electrodes actually leads to the loss of the input power for heating the specimen to be heated, the above electric discharge causes the thermal efficiency to be lowered as in the above case.

A second problem resides in yield. As described above, the annealing apparatus disclosed in Japanese Unexamined Patent Application Publication No. 2012-59872 installs a protective quartz as a protection countermeasure of the reflecting mirror, and a contamination countermeasure of the reflecting mirror. However, because the gap is formed between the reflecting mirror surface and the protective quartz which can be a contamination source, a foreign matter that can be the contamination source is produced from the reflecting mirror, there is a possibility that the foreign matter may be mixed into the specimen to be heated. This causes the yield to be lowered. Also, when the electric discharge is generated by the reflecting mirror, a risk of the contamination from the reflecting mirror is increased, thereby lessening the yield as in the above case.

In view of the above problems, in this embodiment, a description will be given of a heat treatment apparatus that subjects the specimen to be heated to heat treatment which can enhance the thermal efficiency and increase the yield. The matters described in the first embodiment but not described in this embodiment can be also applied to this embodiment unless special circumstances exist.

A basic configuration of the heat treatment apparatus according to this embodiment will be described with reference to FIGS. 6 to 9.

The heat treatment apparatus according to this embodiment includes the heat treatment chamber 100 that heats the specimen 101 to be heated with the use of the plasma 124. FIG. 6 is a vertical cross-sectional view of an outline of the heat treatment chamber 100.

As illustrated in FIG. 6, the heat treatment chamber 100 includes the upper electrode 102 which is a first electrode, the lower electrode 103 which is a heating plate facing the upper electrode 102, the beams 125 that support the lower electrode 103 which is a second electrode, and the stage 104 having the support pins 106 for supporting the specimen 101 to be heated. The heat treatment chamber 100 also includes the heat shields 401 that reduce the radiation loss, support rods 402 that support the heat shields 401 which are radiation loss reduction members, an upper reflecting mirror 120a that is a first reflecting mirror reflecting the radiation heat, a side reflecting mirror 120b that is a second reflecting mirror reflecting the radiation heat, and a lower reflecting mirror 120c that is a third reflecting mirror reflecting the radiation heat. The heat treatment chamber 100 further includes the radio-frequency power supply 111 that supplies a radio-frequency power for plasma generation to the upper electrode 102, the gas introducing means 113 that supplies the gas into the heat treatment chamber 100, and the vacuum valve 116 that adjusts a pressure within the heat treatment chamber 100.

The specimen 101 to be heated is supported on the support pins 106 of the stage 104, and arranged closely below the lower electrode 103. Also, the lower electrode 103 comes out of contact with the specimen 101 to be heated, and the stage 104. In this embodiment, an SiC substrate of 6 inches (φ150 mm) is used as the specimen 101 to be heated. A diameter and a thickness of the upper electrode 102 and the stage 104 are set to 200 mm and 5 mm, respectively.

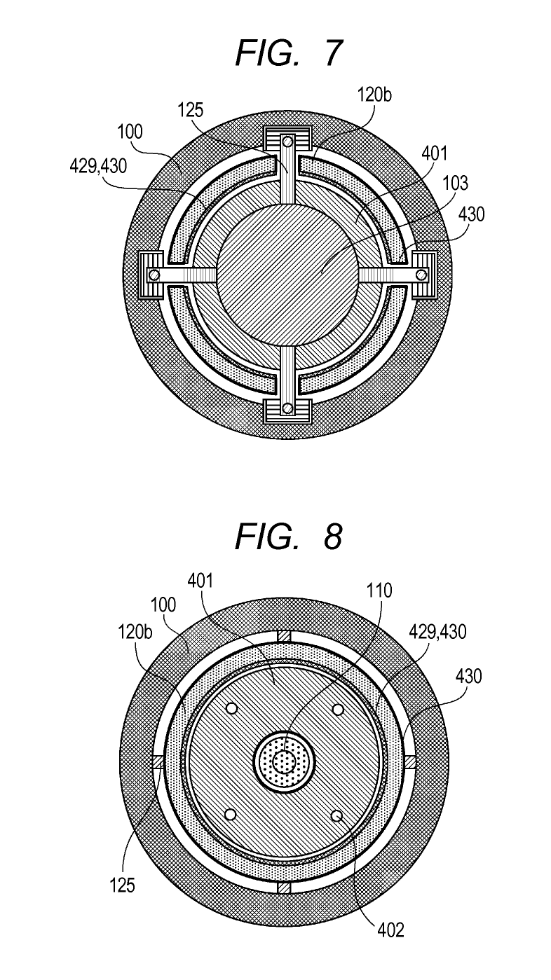

On the other hand, a diameter of the lower electrode 103 is equal to or lower than an inner diameter of the side reflecting mirror 120b, and a thickness of the lower electrode 103 is set to 2 mm. Also, the lower electrode 103 has an inner cylindrical member configured to cover the side surface of the specimen 101 to be heated on an opposite side of a surface facing the upper electrode 102. As illustrated in FIG. 7, the lower electrode 103 includes a disc-shaped member substantially identical in diameter with the upper electrode 102, and four beams arranged at regular intervals so as to connect the above disc-shaped member to the heat treatment chamber 100. FIG. 7 is a top view taken along a cross-section A-A in FIG. 6. Also, the number, the cross-sectional area, and the thickness of the above beams 125 can be determined taking a strength of the lower electrode 103, and the radiation from the lower electrode 103 toward the heat treatment chamber 100 into account.

Because of a structure illustrated in FIG. 6, the lower electrode 103 can inhibit the heat of the lower electrode 103 heated by the plasma 124 from being transferred to the upper reflecting mirror 120a, the side reflecting mirror 120b, and the lower reflecting mirror 120c, and therefore functions as the heating plate high in the thermal efficiency. Further, the plasma 124 generated between the upper electrode 102 and the lower electrode 103 is diffused into the vacuum valve 116 side from a space between the respective beams. However, because the specimen 101 to be heated is covered with the inner cylindrical member, the specimen 101 to be heated is not exposed to the plasma 124. Also, the upper electrode 102, the upper feed line 110, the lower electrode 103, the beams 125, the stage 104, and the support pins 106 are each obtained by depositing SiC on a surface of a graphite base material through a chemical vapor deposition (hereinafter referred to as “CVD technique”). Also, the gap 108 formed between the lower electrode 103 and the upper electrode 102 is set to 0.8 mm. The specimen 101 to be heated has a thickness of about 0.5 mm to 0.8 mm. Also, circumferential corner portions of the respective facing sides of the upper electrode 102 and the lower electrode 103 are tapered or rounded. This is because the plasma localization on the respective corner portions of the upper electrode 102 and the lower electrode 103 due to the concentration of an electric field is suppressed.

The stage 104 is connected to the lifting mechanism 105 through the shaft 107, and the lifting mechanism 105 is operated to enable the specimen 101 to be heated to be delivered, and the specimen 101 to be heated to come closer to the lower electrode 103. Also, the shaft 107 is made of an alumina material.

The radio-frequency power is supplied to the upper electrode 102 from the radio-frequency power supply 111 through an upper feed line 110. In this embodiment, a frequency of the radio-frequency power supply 111 is 13.56 MHz. This is because since 13.56 MHz is an industrial frequency, the power supply is available at low costs, and a standard for electromagnetic wave leakage is also low, thereby being capable of reducing the device costs. However, in principle, it is needless to say that the heat treatment can be conducted at another frequency in the same principle. In particular, a frequency of 1 MHz or higher and 100 MHz or lower is preferable.

When the frequency is lower than 1 MHz, a radio-frequency voltage when supplying an electric power necessary for the heat treatment becomes high, an abnormal discharge (unstable plasma or electric discharge except for the gap between the upper electrode and the lower electrode) is generated, thereby making it difficult to generate stable plasma. Also, in a frequency exceeding 100 MHz, an impedance in the gap 108 between the upper electrode 102 and the lower electrode 103 is low, thereby making it difficult to obtain a voltage necessary for the plasma generation. Therefore, such a frequency is not desirable.

The lower electrode 103 is electrically connected to the heat treatment chamber 100 through the beams 125. Further, the lower electrode 103 is grounded through the beams 125 and the heat treatment chamber 100. The upper feed line 110, the upper electrode 102, the lower electrode 103, and the beams 125 are made of graphite.

The matching circuit 112 (M.B in FIG. 6 is an abbreviation for matching box) is arranged between the radio-frequency power supply 111 and the upper electrode 102, and the radio-frequency power from the radio-frequency power supply 111 is efficiently supplied to the plasma 124 formed between the upper electrode 102 and the lower electrode 103.

The gas can be introduced in a range of from 0.1 atmospheric pressure to 10 atmospheric pressure into the heat treatment chamber 100 in which the upper electrode 102 and the lower electrode 103 are arranged, by the gas introducing means 113. A pressure of the introduced gas is monitored by the pressure detecting means 114. Also, the heat treatment chamber 100 can exhaust gas by the aid of a vacuum pump connected to an exhaust port 115 and the vacuum valve 116.

Further, the upper electrode 102, the lower electrode 103, and the stage 104 are supported by the support rods 402 as illustrated in FIG. 8, and covered with the disc-shaped heat shields 401. Also, the heat shields 401 is structured to be surrounded by the upper reflecting mirror 120a, the side reflecting mirror 120b, and the lower reflecting mirror 120c. FIG. 8 is a top view taking along a cross-section B-B in FIG. 6. In this embodiment, because the heat shields 401 are provided on opposite sides of the respective surfaces of the upper electrode 102, the lower electrode 103, and the stage 104 which are exposed to the plasma 124, the radiation heat from each of the upper electrode 102, the lower electrode 103, and the stage 104 can be reduced, and the thermal efficiency can be enhanced.

The heat shields 401 which are plate material high in melting point and low in radiation factor, or coating high in melting point and low in radiation factor are divided into an upper portion and a lower portion, and the upper heat shield 401 are fixed to the upper reflecting mirror 120a by the support rods 402, and the lower heat shield 401 is fixed to the stage 104. The support rods 402 that support the upper heat shields 401 are each formed of a thin stick-like member made of quartz or ceramic. A material of the support rods 402 is selected from a material having a thermal conductivity as low as possible, and set to a minimum size necessary to support the heat shields 401 to keep a heat transfer loss from the heat shields 401 to the upper reflecting mirror 120a low.

Also, in this embodiment, the heat shields 401 are each formed of a tungsten foil 0.1 mm in thickness. In this embodiment, the heat shields 401 each have an end side wall in a peripheral portion thereof. The end side wall is not essential, but provided to more enhance the thermal efficiency. The end side walls may be formed integrally with heat shield main bodies, but can be machined separately from the heat shield main bodies and coupled together. The heat shields 401 according to this embodiment each have no portion directly contacting with members (upper electrode 102 and lower electrode 103) heated directly by the plasma, and are distant from all of those members.

As a result, because a heating temperature of the heat shields 401 can be reduced, a long-term deterioration of the radiation factor, and the emission of impurities attributable to thermal deterioration can be suppressed. Also, because the heat shields 401 are arranged to surround the upper electrode 102 and the lower electrode 103 which become at a high temperature, even if the sooty foreign matter attributable to those electrodes is produced, the sooty foreign matter is inhibited and prevented from going around the surface of the heat shields 401. Also, the sooty foreign matter can be inhibited and prevented from being attached onto the respective surfaces of the heat shields 401, the upper reflecting mirror 120a, the side reflecting mirror 120b, and the lower reflecting mirror 120c. As a result, a long-term reduction in the radiation factor of the heat shields 401, and a reduction in the respective reflectance of the upper reflecting mirror 120a, the side reflecting mirror 120b, and the lower reflecting mirror 120c can be suppressed.

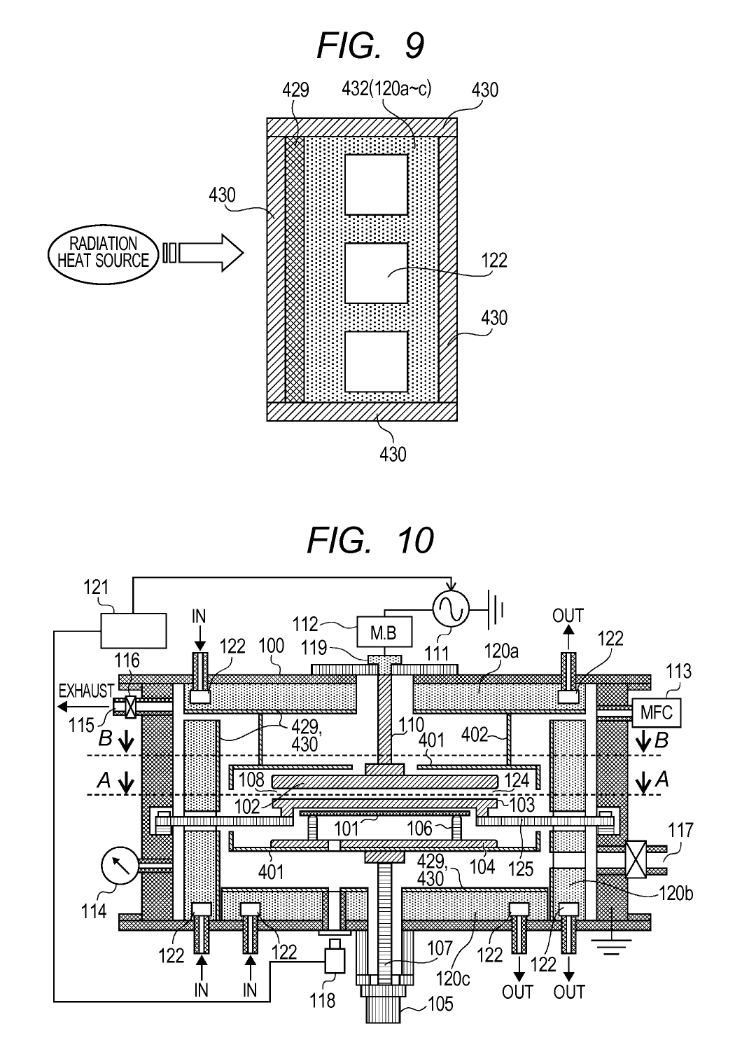

Each of the upper reflecting mirror 120a, the side reflecting mirror 120b, and the lower reflecting mirror 120c is made of a metal base material 432 as illustrated in FIG. 9, and surfaces of the metal base material 432 which face surfaces where a large amount of radiation heat is generated are optically polished. Also, the optically polished surfaces are plated with a metal film 429 of a low radiation, or coated with the metal film 429 through vapor deposition. In this embodiment, the metal film 429 of the low radiation is formed of an Au (gold) film high in reflectance in the visible light region to the infrared ray region. Alternatively, the same advantage as that of the Au (gold) film is obtained even if an Ag (silver) film, a Cu (copper) film, or a silver alloy film is used.

Further, a protective film 430 is coated on the metal film 429 of the low radiation. Also, the surface of the metal base material 432 which does not face the surface where a large amount of radiation heat is generated is coated with the protective film 430 except for the respective surfaces of the upper reflecting mirror 120a, the side reflecting mirror 120b, and the lower reflecting mirror 120c which are assembled into the heat treatment chamber 100. FIG. 9 is a schematic diagram of the upper reflecting mirror 120a, the side reflecting mirror 120b, and the lower reflecting mirror 120c.

Also, in this embodiment, quartz (SiO₂) which is a high transmission and an insulating material is used as the protective film 430. Alternatively, the same advantages are obtained even if calcium fluoride (CaF₂), sapphire (Al₂O₂), barium fluoride (BaF₂), and lithium fluoride (LiF), or magnesium fluoride (MgF₂) is used.

In general, a mechanism of the heat transfer mechanism can be classified into three sub-mechanisms of (1) heat conduction, (2) radiation, and (3) heat transfer by convection. When the temperature is about 700° C. or higher, (2) the heat transfer by the radiation is mainstream. Also, as the feature of the radiation heat, when the temperature is low, the radiation in the region of the far infrared rays is major. The radiation of the short wavelength region becomes gradually major toward the higher temperature, and an absolute amount of the long wavelength region is also more increased.

For reference, the optical characteristics of quartz are different depending on the material and the manufacturing method. However, for example, quartz such as an electric melting product is as high as 80% or higher in the transmission in the wavelength region from the visible light to the near infrared rays (0.3 to 3.0 μm). However, in the wavelength region (from about 3.0 μm) of the middle wavelength or higher, the quartz exhibits the optical characteristics that the transmission is remarkably lowered.

For that reason, when the specimen 101 to be heated is thermally treated in the temperature region of 1200 to 1800° C., the radiation of the wavelength close to the wavelength region (0.75 to 3.0 μm) from the near infrared rays to the short wavelength infrared rays is a major radiation. However, because a considerable amount of radiation of the wavelength of 3.0 μm or higher also exists as the absolute amount, the radiation loss in the quartz as the protective material can be also ignored from the viewpoints of the thermal efficiency. Also, because the amount of radiation absorbed by quartz increases in proportion to the thickness of quartz, the heating efficiency is remarkably lowered as quartz is thicker, in the temperature region where the radiation heat is major.

From the above viewpoints, in this embodiment, the thickness of the protective film 430 is set to about 5 μm. However, the thickness may range from 0.1 μm to 10 μm. The heating efficiency is more enhanced as the thickness of the protective film 430 is thinner. When the thickness of the protective film 430 becomes 0.1 μm or lower, for example, a risk that electric discharge is generated between the upper feed line 110 and the upper reflecting mirror 120a is higher, and a problem on contamination comes up. Therefore, this case is not preferable. Also, if the thickness of the protective film 430 is larger than 10 μm, the radiation loss becomes larger, and the heating efficiency is lowered. Therefore, this case is not preferable. For that reason, in the present invention, the thickness of the protective film 430 ranges from 0.1 μm to 10 μm.

Further, the cooling passage 122 is formed in each of the upper reflecting mirror 120a, the side reflecting mirror 120b, and the lower reflecting mirror 120c. The cooling water is allowed to flow into the cooling passage 122 whereby the respective temperatures of the upper reflecting mirror 120a, the side reflecting mirror 120b, and the lower reflecting mirror 120c can be maintained at a desired temperature or lower. For that reason, the metal film 429 of the low radiation and the protective film 430 are difficult to separate from each other.

Because the heat treatment chamber 100 includes the upper reflecting mirror 120a, and the side reflecting mirror 120b, and the lower reflecting mirror 120c, the radiation heat from the upper electrode 102, the lower electrode 103, and the stage 104 can be reflected by the upper reflecting mirror 120a, the side reflecting mirror 120b, and the lower reflecting mirror 120c, respectively. For that reason, the thermal efficiency can be enhanced.

Also, the protective film 430 prevents the surface of the metal film 429 of the low radiation from being contaminated with a sublimate from each of the upper electrode 102, the lower electrode 103, and the stage 104 which are at an ultrahigh temperature. Also, the protective film 430 function as a protective material for preventing the contamination likely to be mixed into the specimen 101 to be heated from each of the upper reflecting mirror 120a, the side reflecting mirror 120b, and the lower reflecting mirror 120c.

Also, in particular, the protective film 430 coated on the surface of the metal base material 432 which does not face the surface on which a large amount of radiation heat is generated also has a function of preventing the electric discharge from being generated between a neighborhood portion of the high potential (for example, the upper feed line 110) and the metal base material 432 together. With this function, the radio-frequency power supplied from the radio-frequency power supply 111 is efficiently consumed for generation of the plasma 124 formed between the upper electrode 102 and the lower electrode 103. Also, for example, when the electric discharge is generated between the upper feed line 110 and the upper reflecting mirror 120a, the foreign matter and the contamination are comprehended. However, because the electric discharge can be inhibited from being generated, there is no need to comprehend the above foreign matter and the contamination.

From the above viewpoints, the upper reflecting mirror 120a, the side reflecting mirror 120b, and the lower reflecting mirror 120c are totally covered with the protective film 430. As a result, a risk of the electric discharge between each of the upper reflecting mirror 120a, the 120b, and the lower reflecting mirror 120c, and the high potential can be reduced. The contamination caused by the sublimate from each of the upper electrode 102, the lower electrode 103, and the stage 104 which are at an ultrahigh temperature, and the contamination likely to be mixed into the specimen 101 to be heated can be prevented. Further, the thermal efficiency can be inhibited from being lowered.

Also, when a product of quartz is used as the protective material for prevention of the contamination, the thickness of about 1 to 3 mm is required from the viewpoints of the workability and operability. However, in this embodiment, because the protective film 430 is coated on the metal film 429 or the metal base material 432 of the low radiation as the protective material, the thickness of quartz can be suppressed to about 0.1 to 10 μm. For that reason, when the thickness of the protective film 430 in this embodiment is compared with the thickness of the product of quartz, the thickness of the protective film 430 is thinned to about 1/100 to 1/30000 depending on the product of quartz, and the radiation loss by the protective material can be minimized.

Subsequently, a basic operation example of the heat treatment apparatus according to this embodiment will be described. First, the He gas within the heat treatment chamber 100 is exhausted from the exhaust port 115 into a high vacuum state. In a stage where the sufficient gas exhaust has been finished, the exhaust port 115 is closed, the gas is introduced by the gas introducing means 113, and the interior of the heat treatment chamber 100 is controlled to 0.6 atmospheric pressure. In this embodiment, the gas introduced into the heat treatment chamber 100 is He.

The specimen 101 to be heated preheated in a spare chamber (not shown) at 400° C. is transported from a transport port 117, and is supported on the support pins 106 of the stage 104. After the specimen 101 to be heated has been supported on the support pins 106 of the stage 104, the stage 104 is lifted up to a given position by the lifting mechanism 105. In this embodiment, the given position is set to a position at which a distance between a lower surface of the lower electrode 103 and the surface of the specimen 101 to be heated is 0.5 mm.

In this embodiment, the distance between the lower surface of the lower electrode 103 and the surface of the specimen 101 to be heated is set to 0.5 mm, but may range from 0.1 mm to 2 mm. The thermal efficiency becomes higher as the specimen 101 to be heated comes closer to the lower surface of the lower electrode 103.

However, a risk that the lower electrode 103 and the specimen 101 to be heated come into contact with each other becomes higher, or a problem on contamination more occurs as the specimen 101 to be heated comes closer to the lower surface of the lower electrode 103. Therefore, it is not preferable that the above distance is lower than 0.1 mm. Also, it is not preferable that the distance is larger than 2 mm, because the heating efficiency is lowered, and the radio-frequency power necessary for heating becomes large. For that reason, the proximity in this embodiment is set to the distance of from 0.1 mm to 2 mm.

After the stage 104 has been lifted to the given position, the radio-frequency power from the radio-frequency power supply 111 is supplied to the upper electrode 102 through the matching circuit 112 and a power introduction terminal 119, and the plasma is generated within the gap 108 to heat the specimen 101 to be heated.

An energy of the radio-frequency power is absorbed by electrons within the plasma 124, and atoms or molecules of a raw gas are heated by collision of the electrons. Also, ions generated by ionization are accelerated by a potential difference generated in a sheath on the surfaces of the upper electrode 102 and the lower electrode 103 which come into contact with the plasma, and are input to the upper electrode 102 and the lower electrode 103 while colliding with the raw gas. Through the above collision process, the temperature of the gas filled between the upper electrode 102 and the lower electrode 103, and the temperatures of the surfaces of the upper electrode 102 and the lower electrode 103 can be raised.

In particular, in the almost atmospheric pressure as in this embodiment, since the ions frequently collide with the raw gas when passing through the sheath, it is conceivable that the raw gas filled between the upper electrode 102 and the lower electrode 103 can be efficiently heated.

As a result, the temperature of the raw gas can be easily heated up to about 1200 to 2000° C.

The upper electrode 102 and the lower electrode 103 are heated by bringing the heated high-temperature gas into contact with the upper electrode 102 and the lower electrode 103. Also, a part of a neutral gas excited by the electron collision is deexcited with light emission, and the upper electrode 102 and the lower electrode 103 are also heated by the light emission in this situation. Further, the stage 104 and the specimen 101 to be heated are heated by going-around of the high-temperature gas, and the radiation from the upper electrode 102 and the lower electrode 103 which have been heated.

In this example, since the lower electrode 103 that is the heating plate is disposed closely above the specimen 101 to be heated, the specimen 101 to be heated is heated after the lower electrode 103 has been heated by the gas heated at a high temperature by the aid of the plasma 124, to thereby obtain an advantage that the specimen 101 to be heated is evenly heated. Also, with the provision of the stage 104 below the lower electrode 103, an even electric field is formed between the lower electrode 103 and the upper electrode 102 regardless of a configuration of the specimen 101 to be heated, thereby enabling the uniform plasma to be generated.

Further, the specimen 101 to be heated is arranged below the lower electrode 103, as a result of which the specimen 101 to be heated is not exposed directly to the plasma 124 formed in the gap 108. Also, even when the discharge transitions from the glow discharge to the arc discharge, a discharge current flows into the lower electrode 103 without passing through the specimen 101 to be heated. As a result, the specimen 101 to be heated can be prevented from being damaged.

The temperature of the lower electrode 103 or the stage 104 during the heat treatment is measured by the radiation thermometer 118, and an output of the radio-frequency power supply 111 is controlled so that the above temperature reaches a given temperature by a control device 121 with the use of a measured value. Therefore, the temperature of the specimen 101 to be heated can be controlled with a high precision. In this embodiment, the radio-frequency power to be input is set to 20 kW at the maximum.

Also, the plasma 124 of the heating source is set as plasma in a grow discharge region so that the plasma 124 evenly spread can be formed between the upper electrode 102 and the lower electrode 103, and the specimen 101 to be heated is heated with the even and planar plasma 124 as a heat source so that the planar specimen 101 to be heated can be evenly heated. Upon completion of the above heat treatment, in a stage where the temperature of the specimen 101 to be heated falls below 800° C., the specimen 101 to be heated is carried out of the transport port 117, a subsequent specimen 101 to be heated is transported into the heat treatment chamber 100, and supported on the support pins 106 of the stage 104, and the operation of the above-mentioned heat treatment is repeated.

In this embodiment, the pressure within the heat treatment chamber 100 for plasma generation is set to 0.6 atmospheric pressure. However, the same operation is enabled even under the atmospheric pressure of 10 atmospheric pressure or lower. If the pressure exceeds 10 atmospheric pressure, even glow discharge is difficult to generate. In this embodiment, He gas is used in the raw gas for plasma generation. In addition, the same advantages are obtained even if a gas using an inert gas such as Ar, Xe, or Kr as a main raw material is used. The He gas used in this embodiment is excellent in the plasma ignition and stability under the substantially atmospheric pressure. However, the thermal conductivity of the gas is high, and the heat loss due to heat transfer through the gas atmosphere is relatively large. On the other hand, a gas large in mass such as Ar, Xe, or Kr gas is low in the thermal conductivity, and therefore superior to the He gas from the viewpoint of the thermal efficiency.

Further, in this embodiment, the radiation loss from each of the upper electrode 102, the lower electrode 103, and the stage 104 is reduced by the heat shields 401, and the radiation light is returned to the upper electrode 102, the lower electrode 103, and the stage 104 by each of the upper reflecting mirror 120a, the side reflecting mirror 120b, and the lower reflecting mirror 120c, thereby being capable of improving the heating efficiency. Even if only the heat shields 401 are applied to the upper electrode 102, the lower electrode 103, and the stage 104, an improvement in the heating efficiency can be expected. Likewise, even if only the upper reflecting mirror 120a, the side reflecting mirror 120b, and the lower reflecting mirror 120c are applied thereto, an improvement in the heating efficiency can be expected.

In this embodiment, the heat release from each of the upper electrode 102, the lower electrode 103, and the stage 104, which affects the heating efficiency mainly includes (1} radiation, (2) heat transfer of gas atmosphere, and (3) heat transfer from the upper feed line 110 and the shaft 107. When the heat treatment is conducted at 1200° C. or higher, a main factor of the heat release largest among those factors is (1) radiation.

From the above viewpoints, in this embodiment, in order to suppress the radiation of (1), the heat shields 401 are disposed on opposite sides of the surfaces of the upper electrode 102, the lower electrode 103, and the stage 104, which are exposed to the plasma 124. Also, in order to minimize the radiation loss, the protective film 430 which is a protective material for preventing the contamination from each of the upper reflecting mirror 120a, the side reflecting mirror 120b, and the lower reflecting mirror 120c is coated on each of the upper reflecting mirror 120a, the side reflecting mirror 120b, and the lower reflecting mirror 120c.

Also, with the configuration of this embodiment, a reduction in the thermal efficiency due to the radiation of (1) can be suppressed, and a reduction in the thermal efficiency due to the electric discharge generated except for the gap between the upper electrode 102 and the lower electrode 103 can be also suppressed. For that reason, when the electric discharge generated except for the gap between the upper electrode 102 and the lower electrode 103 can be suppressed under the heat treatment condition, with a configuration illustrated in FIG. 10, a reduction in the thermal efficiency due to the radiation of (1) can be suppressed, and the radiation loss is minimized. FIG. 10 is a longitudinal cross-sectional view of an outline of the heat treatment chamber 100, and in FIG. 5, parts indicated by the same symbols in FIG. 1A have the same functions as those in the heat treatment chamber 100 of FIG. 6 in this embodiment, and therefore a description thereof will be omitted.

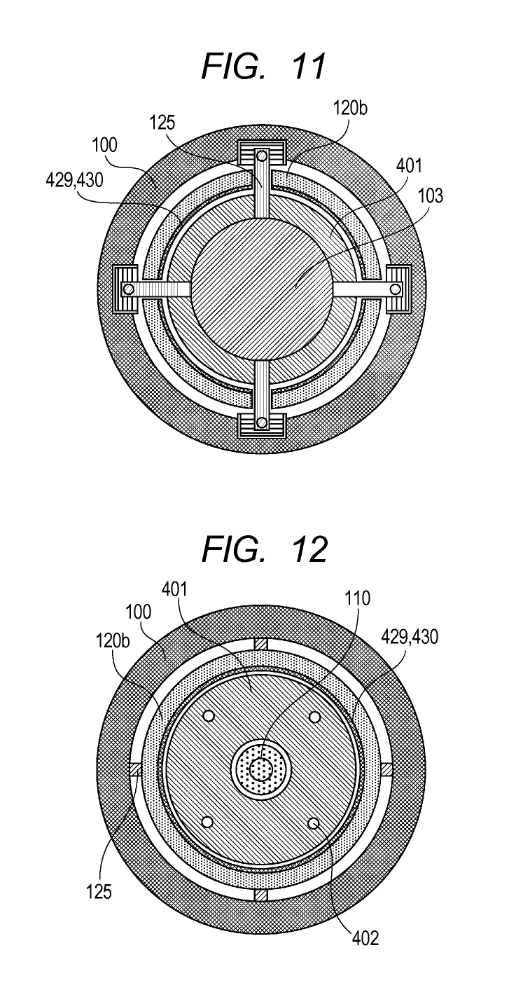

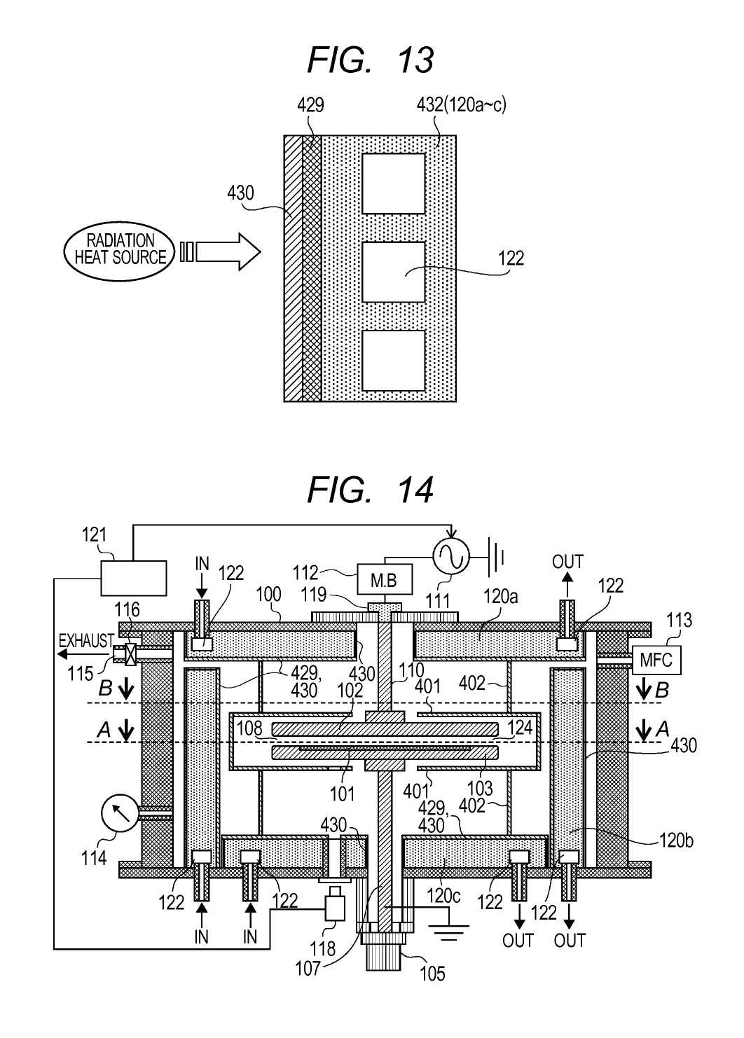

A difference between the heat treatment chamber 100 illustrated in FIG. 10 and the heat treatment chamber 100 illustrated in FIG. 6 resides in that only the surface of the metal base material 432 which faces the surfaces of the upper reflecting mirror 120a, the side reflecting mirror 120b, and the lower reflecting mirror 120c disposed within the heat treatment chamber 100 illustrated in FIG. 10 where a large amount of radiation heat is generated as illustrated in FIGS. 10 to 13 is optically polished, and the surface optically polished is plated with the metal film 429 of the low radiation, or coated with the metal film 429 through vapor deposition. Further, the protective film 430 is coated on the metal film 429 of the low radiation. FIG. 11 is a top view taken along a cross-section A-A in FIG. 10, and FIG. 12 is a top view taken along a cross-section B-B in FIG. 10. Also, FIG. 13 is a schematic diagram illustrating the upper reflecting mirror 120a, the side reflecting mirror 120b, and the lower reflecting mirror 120c.

Hereinafter, the advantages of this embodiment are summarized. In the heat treatment apparatus according to the present invention, the specimen 101 to be heated is heated with the gas heating associated with the glow discharge generated in the narrow gap as the heat source. The following two advantages indicated below which are not obtained in the related art are obtained with this heating principle.

A first advantage resides in the thermal efficiency. The gas in the gap 108 is extremely small in the heat capacity. Also, the heat shields 401 are arranged between the upper electrode 102, the lower electrode 103, and the stage 104, and the upper reflecting mirror 120a, the side reflecting mirror 120b, and the lower reflecting mirror 120c, respectively. Also, as a protective material for preventing the contamination from each of the upper reflecting mirror 120a, the side reflecting mirror 120b, and the lower reflecting mirror 120c, the protective film 430 is coated on each surface of the upper reflecting mirror 120a, the side reflecting mirror 120b, and the lower reflecting mirror 120c. With this configuration, the specimen 101 to be heated can be heated with a system in which the heating loss attributable to the radiation is extremely reduced.

A second advantage resides in the productivity. In the heat treatment apparatus according to the present invention, in each of the upper reflecting mirror 120a, the side reflecting mirror 120b, and the lower reflecting mirror 120c, the protective film 430 is coated on the surface of the metal film 429 of the low radiation which has been plated or evaporated which can be a contamination source. As a result, the contamination source can be covered directly with the protective film 430 to prevent the contamination and improve the yield property.

From the above viewpoints, the heat treatment apparatus according to the present invention can enhance the thermal efficiency and the yield property even if the specimen to be heated is heated at 1200° C. or higher.

### Third Embodiment

The second embodiment represents an example in which the present invention is applied to the heat treatment apparatus that heats the specimen to be heated indirectly from the plasma. On the other hand, in this embodiment, a description will be given of an example in which the present invention is applied to the heat treatment apparatus that heats the specimen to be heated directly from the plasma. Hereinafter, a basis configuration of the heat treatment apparatus according to this embodiment will be described with reference to FIGS. 9, 14 to 16.

The heat treatment apparatus according to this embodiment includes the heat treatment chamber 100 that heats the specimen 101 to be heated with the use of the plasma 124. FIG. 14 is a vertical cross-sectional view of an outline of the heat treatment chamber 100. As illustrated in FIG. 14, the heat treatment chamber 100 includes the upper electrode 102 which is a first electrode, the lower electrode 103 which is a second embodiment on which the specimen 101 to be heated is mounted, and which faces the upper electrode 102, the heat shields 401 that reduce the radiation loss, the support rods 402 that support the heat shields 401 which are the radiation loss reduction members, the upper reflecting mirror 120a that is the first reflecting mirror reflecting the radiation heat, the side reflecting mirror 120b that is the second reflecting mirror reflecting the radiation heat, and the lower reflecting mirror 120c that is the third reflecting mirror reflecting the radiation heat. The heat treatment chamber 100 also includes the radio-frequency power supply 111 that supplies a radio-frequency power for plasma generation to the upper electrode 102, the gas introducing means 113 that supplies the gas into the heat treatment chamber 100, and the vacuum valve 116 that adjusts a pressure within the heat treatment chamber 100.

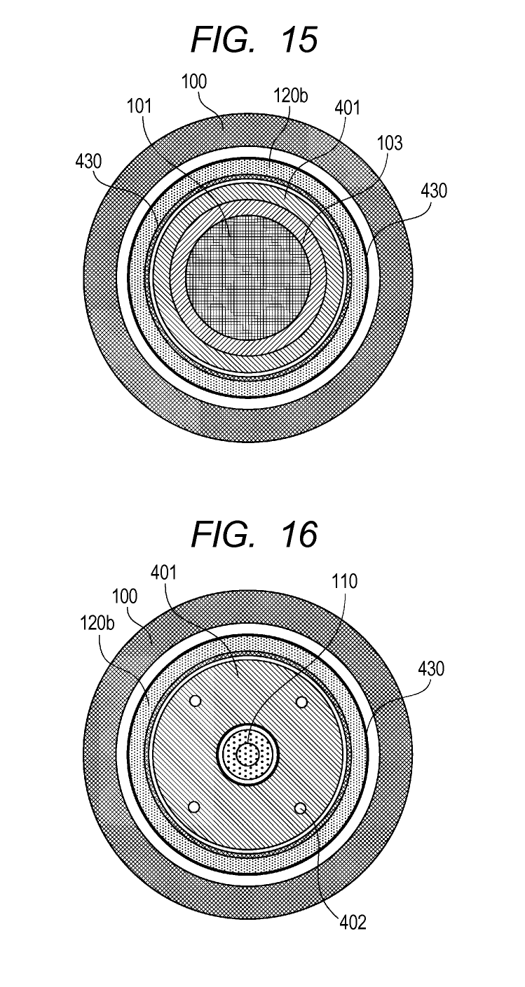

In this embodiment, an SiC substrate of 6 inches (φ150 mm) is used as the specimen 101 to be heated. Also, as illustrated in FIG. 15, the upper electrode 102 and the lower electrode 103 are disc-shaped, and a diameter and a thickness of the upper electrode 102 and the lower electrode 103 are set to 200 mm and 5 mm, respectively. Further, the specimen 101 to be heated has a thickness of about 0.5 mm to 0.8 mm, and a recess for allowing the specimen 101 to be heated to be placed therein is formed in the lower electrode 103 on which the specimen to be heated is placed. FIG. 15 is a top view taken along a cross-section A-A in FIG. 14.

As illustrated in FIG. 14, because the upper electrode 102 and the lower electrode 103 are structured to be surrounded by the upper reflecting mirror 120a, the side reflecting mirror 120b, and the lower reflecting mirror 120c, the heat treatment chamber 100 can conduct the heat treatment high in the thermal efficiency. Also, the upper electrode 102, the upper feed line 110, and the lower electrode 103 are each obtained by depositing SiC on a surface of a graphite base material through a chemical vapor deposition (hereinafter referred to as “CVD technique”). Also, the gap 108 formed between the lower electrode 103 and the upper electrode 102 is set to 0.8 mm. Also, circumferential corner portions of the respective facing sides of the upper electrode 102 and the lower electrode 103 are tapered or rounded. This is because the plasma localization on the respective corner portions of the upper electrode 102 and the lower electrode 103 due to the concentration of an electric field is suppressed.

The radio-frequency power is supplied to the upper electrode 102 from the radio-frequency power supply 111 through an upper feed line 110, and the lower electrode 103 is grounded to the lower electrode 103. In this embodiment, a frequency of the radio-frequency power supply 111 is 13.56 MHz. This is because since 13.56 MHz is an industrial frequency, the power supply is available at low costs, and a standard for electromagnetic wave leakage is also low, thereby being capable of reducing the device costs. However, in principle, it is needless to say that the heat treatment can be conducted at another frequency in the same principle. In particular, a frequency of 1 MHz or higher and 100 MHz or lower is preferable.

When the frequency is lower than 1 MHz, a radio-frequency voltage when supplying an electric power necessary for the heat treatment becomes high, an abnormal discharge (unstable plasma or electric discharge except for the gap between the upper electrode and the lower electrode) is generated, thereby making it difficult to generate stable plasma. Also, in a frequency exceeding 100 MHz, an impedance in the gap 108 between the upper electrode 102 and the lower electrode 103 is low, thereby making it difficult to obtain a voltage necessary for the plasma generation. Therefore, such a frequency is not desirable.

The matching circuit 112 (M.B in FIG. 6 is an abbreviation for matching box) is arranged between the radio-frequency power supply 111 and the upper electrode 102, and the radio-frequency power from the radio-frequency power supply 111 is efficiently supplied to the plasma 124 formed between the upper electrode 102 and the lower electrode 103.

The gas can be introduced in a range of from 0.1 atmospheric pressure to 10 atmospheric pressure into the heat treatment chamber 100 in which the upper electrode 102 and the lower electrode 103 are arranged, by the gas introducing means 113. A pressure of the introduced gas is monitored by the pressure detecting means 114. Also, the heat treatment chamber 100 can exhaust gas by the aid of a vacuum pump connected to an exhaust port 115 and the vacuum valve 116.

Further, the upper electrode 102 and the lower electrode 103 are supported by the support rods 402 as illustrated in FIG. 16, and covered with the disc-shaped heat shields 401. Also, the heat shields 401 is structured to be surrounded by the upper reflecting mirror 120a, the side reflecting mirror 120b, and the lower reflecting mirror 120c. FIG. 16 is a top view taking along a cross-section B-B in FIG. 16. In this embodiment, because the heat shields 401 are provided on opposite sides of the respective surfaces of the upper electrode 102 and the lower electrode 103, which are exposed to the plasma 124, the radiation heat from each of the upper electrode 102 and the lower electrode 103 can be reduced, and the thermal efficiency can be enhanced.

The heat shields 401 which are plate material high in melting point and low in radiation factor, or coating high in melting point and low in radiation factor are divided into an upper portion and a lower portion, and the upper heat shield 401 are fixed to the upper reflecting mirror 120a by the support rods 402, and the lower heat shield 401 is fixed to the lower reflecting mirror 120c by the support rods 402. The support rods 402 that support the upper and lower heat shields 401 are each formed of a thin stick-like member made of quartz or ceramic. A material of the support rods 402 is selected from a material having a thermal conductivity as low as possible, and set to a minimum size necessary to support the heat shields 401 to keep a heat transfer loss from the heat shields 401 to the upper reflecting mirror 120a low.

Also, in this embodiment, the heat shields 401 are each formed of a tungsten foil 0.1 mm in thickness. In this embodiment, the heat shields 401 each have an end side wall in a peripheral portion thereof. The end side wall is not essential, but provided to more enhance the thermal efficiency. The end side walls may be formed integrally with heat shield main bodies, but can be machined separately from the heat shield main bodies and coupled together. The heat shields 401 according to this embodiment each have no portion directly contacting with members (upper electrode 102 and lower electrode 103) heated directly by the plasma, and are distant from all of those members.

As a result, because the heating temperature of the heat shields 401 can be reduced, a long-term deterioration of the radiation factor, and the emission of impurities attributable to thermal deterioration can be suppressed. Also, because the heat shields 401 are arranged to surround the upper electrode 102 and the lower electrode 103 which become at a high temperature, even if the sooty foreign matter attributable to those electrodes is produced, the sooty foreign matter is inhibited and prevented from going around the surface of the heat shields 401. Also, the sooty foreign matter can be inhibited and prevented from being attached onto the respective surfaces of the heat shields 401, the upper reflecting mirror 120a, the side reflecting mirror 120b, and the lower reflecting mirror 120c. As a result, a long-term reduction in the radiation factor of the heat shields 401, and a reduction in the respective reflectance of the upper reflecting mirror 120a, the side reflecting mirror 120b, and the lower reflecting mirror 120c can be suppressed.

Each of the upper reflecting mirror 120a, the side reflecting mirror 120b, and the lower reflecting mirror 120c is made of a metal base material 432 as illustrated in FIG. 9, and the surfaces of the metal base material 432 which face surfaces where a large amount of radiation heat is generated are optically polished. Also, the optically polished surfaces are plated with a metal film 429 of a low radiation, or coated with the metal film 429 through vapor deposition. In this embodiment, the metal film 429 of the low radiation is formed of an Au (gold) film high in reflectance in the visible light region to the infrared ray region. Alternatively, the same advantage as that of the Au (gold) film is obtained even if an Ag (silver) film, a Cu (copper) film, or a silver alloy film is used.

Further, the protective film 430 is coated on the metal film 429 of the low radiation. Also, the surface of the metal base material 432 which does not face the surface where a large amount of radiation heat is generated is coated with the protective film 430 except for the respective surfaces of the upper reflecting mirror 120a, the side reflecting mirror 120b, and the lower reflecting mirror 120c which are assembled into the heat treatment chamber 100. FIG. 9 is a schematic diagram of the upper reflecting mirror 120a, the side reflecting mirror 120b, and the lower reflecting mirror 120c.

Also, in this embodiment, quartz (SiO₂) which is a high transmission and an insulating material is used as the protective film 430. Alternatively, the same advantages are obtained even if calcium fluoride (CaF₂), sapphire (Al₂O₂), barium fluoride (BaF₂), and lithium fluoride (LiF), or magnesium fluoride (MgF₂) is used.

In general, a mechanism of the heat transfer mechanism can be classified into three sub-mechanisms of (1) heat conduction, (2) radiation, and (3) heat transfer by convection. When the temperature is about 700° C. or higher, (2) the heat transfer by the radiation is mainstream. Also, as the feature of the radiation heat, when the temperature is low, the radiation in the region of the far infrared rays is major. The radiation of the short wavelength region becomes gradually major toward the higher temperature, and an absolute amount of the long wavelength region is also more increased.

For reference, the optical characteristics of quartz are different depending on the material and the manufacturing method. However, for example, quartz such as an electric melting product is as high as 80% or higher in the transmission in the wavelength region from the visible light to the near infrared rays (0.3 to 3.0 μm). However, in the wavelength region (from about 3.0 μm) of the middle wavelength or higher, the quartz exhibits the optical characteristics that the transmission is remarkably lowered.

For that reason, when the specimen 101 to be heated is thermally treated in the temperature region of 1200 to 1800° C., the radiation of the wavelength close to the wavelength region (0.75 to 3.0 μm) from the near infrared rays to the short wavelength infrared rays is a major radiation. However, because a considerable amount of radiation of the wavelength of 3.0 μm or higher also exists as the absolute amount, the radiation loss in the quartz as the protective material can be also ignored from the viewpoints of the thermal efficiency. Also, because the amount of radiation absorbed by quartz increases in proportion to the thickness of quartz, the heating efficiency is remarkably lowered as quartz is thicker, in the temperature region where the radiation heat is major.

From the above viewpoints, in this embodiment, the thickness of the protective film 430 is set to about 5 μm. However, the thickness may range from 0.1 μm to 10 μm. The heating efficiency is more enhanced as the thickness of the protective film 430 is thinner. When the thickness of the protective film 430 becomes 0.1 μm or lower, for example, a risk that electric discharge is generated between the upper feed line 110 and the upper reflecting mirror 120a is higher, and a problem on contamination comes up. Therefore, this case is not preferable. Also, if the thickness of the protective film 430 is larger than 10 μm, the radiation loss becomes larger, and the heating efficiency is lowered. Therefore, this case is not preferable. For that reason, in the present invention, the thickness of the protective film 430 ranges from 0.1 μm to 10 μm.

Further, the cooling passage 122 is formed in each of the upper reflecting mirror 120a, the side reflecting mirror 120b, and the lower reflecting mirror 120c. The cooling water is allowed to flow into the cooling passage 122 whereby the respective temperatures of the upper reflecting mirror 120a, the side reflecting mirror 120b, and the lower reflecting mirror 120c can be maintained at a desired temperature or lower. For that reason, the metal film 429 and the protective film 430 of the low radiation are difficult to separate from each other.

Because the heat treatment chamber 100 includes the upper reflecting mirror 120a, and the side reflecting mirror 120b, and the lower reflecting mirror 120c, the radiation heat from the upper electrode 102, the lower electrode 103, and the stage 104 can be reflected by the upper reflecting mirror 120a, the side reflecting mirror 120b, and the lower reflecting mirror 120c, respectively. For that reason, the thermal efficiency can be enhanced.

Also, the protective film 430 prevents the surface of the metal film 429 of the low radiation from being contaminated with a sublimate from each of the upper electrode 102 and the lower electrode 103 which are at an ultrahigh temperature. Also, the protective film 430 function as a protective material for preventing the contamination likely to be mixed into the specimen 101 to be heated from each of the upper reflecting mirror 120a, the side reflecting mirror 120b, and the lower reflecting mirror 120c.

Also, in particular, the protective film 430 coated on the surface of the metal base material 432 which does not face the surface on which a large amount of radiation heat is generated also has a function of preventing the electric discharge from being generated between a neighborhood portion of the high potential (for example, the upper feed line 110) and the metal base material 432 together. With this function, the radio-frequency power supplied from the radio-frequency power supply 111 is efficiently consumed for generation of the plasma 124 formed between the upper electrode 102 and the lower electrode 103. Also, for example, when the electric discharge is generated between the upper feed line 110 and the upper reflecting mirror 120a, the foreign matter and the contamination are comprehended. However, because the electric discharge can be inhibited from being generated, there is no need to comprehend the above foreign matter and the contamination.

From the above viewpoints, the upper reflecting mirror 120a, the side reflecting mirror 120b, and the lower reflecting mirror 120c are totally covered with the protective film 430.

As a result, a risk of the electric discharge between each of the upper reflecting mirror 120a, the 120b, and the lower reflecting mirror 120c, and the high potential can be reduced. The contamination caused by the sublimate from each of the upper electrode 102 and the lower electrode 103, which are at an ultrahigh temperature, and the contamination likely to be mixed into the specimen 101 to be heated can be prevented. Further, the thermal efficiency can be also inhibited from being lowered.

Also, when a product of quartz is used as the protective material for prevention of the contamination, the thickness of about 1 to 3 mm is required from the viewpoints of the workability and operability. However, in this embodiment, because the protective film 430 is coated on the metal film 429 of the low radiation or the metal base material 432 of the low radiation as the protective material, the thickness of quartz can be suppressed to about 0.1 to 10 μm. For that reason, when the thickness of the protective film 430 in this embodiment is compared with the thickness of the product of quartz, the thickness of the protective film 430 is thinned to about 1/100 to 1/30000 depending on the product of quartz, and the radiation loss by the protective material can be minimized.

Subsequently, a basic operation example of the heat treatment apparatus according to this embodiment will be described. First, the He gas within the heat treatment chamber 100 is exhausted from the exhaust port 115 into a high vacuum state. In a stage where the sufficient gas exhaust has been finished, the exhaust port 115 is closed, the gas is introduced by the gas introducing means 113, and the interior of the heat treatment chamber 100 is controlled to 0.6 atmospheric pressure. In this embodiment, the gas introduced into the heat treatment chamber 100 is He.

After the specimen 101 to be heated preheated in a spare chamber (not shown) at 400° C. is placed on the lower electrode 103, the radio-frequency power is supplied from the radio-frequency power supply 111 to the upper electrode 102 through the matching circuit 112 and the power introduction terminal 119, and the plasma 124 is generated within the gap 108 to heat the specimen 101 to be heated. An energy of the radio-frequency power is absorbed by electrons within the plasma 124, and atoms or molecules of a raw gas are heated by collision of the electrons.

Also, ions generated by ionization are accelerated by a potential difference generated in a sheath on the surfaces of the upper electrode 102 and the lower electrode 103 which come into contact with the plasma, and are input to the upper electrode 102 and the lower electrode 103 while colliding with the raw gas. Through the above collision process, the temperature of the gas filled between the upper electrode 102 and the lower electrode 103, and the temperatures of the surfaces of the upper electrode 102 and the lower electrode 103 can be raised.

In particular, in the almost atmospheric pressure as in this embodiment, since the ions frequently collide with the raw gas when passing through the sheath, it is conceivable that the raw gas filled between the upper electrode 102 and the lower electrode 103 can be efficiently heated.

As a result, the temperature of the raw gas can be easily heated up to about 1200 to 2000° C. The upper electrode 102 and the lower electrode 103 are heated by bringing the heated high-temperature gas into contact with the upper electrode 102 and the lower electrode 103. Also, a part of a neutral gas excited by the electron collision is deexcited with light emission, and the upper electrode 102 and the lower electrode 103 are also heated by the light emission in this situation.

Further, the specimen 101 to be heated are heated by going-around of the high-temperature gas, and the radiation from the upper electrode 102 and the lower electrode 103 which have been heated.

The temperature of the lower electrode 103 during the heat treatment is measured by the radiation thermometer 118, and an output of the radio-frequency power supply 111 is controlled so that the above temperature reaches a given temperature by a control device 121 with the use of a measured value. Therefore, the temperature of the specimen 101 to be heated can be controlled with a high precision. In this embodiment, the radio-frequency power to be input is set to 20 kW at the maximum.

Also, the plasma 124 of the heating source is set as plasma in a grow discharge region so that the plasma 124 evenly spread can be formed between the upper electrode 102 and the lower electrode 103, and the specimen 101 to be heated is heated with the even and planar plasma 124 as a heat source so that the planar specimen 101 to be heated can be evenly heated. Upon completion of the above heat treatment, in a stage where the temperature of the specimen 101 to be heated falls below 800° C., the specimen 101 to be heated is carried out of the heat treatment chamber 100, a subsequent specimen 101 to be heated is transported into the heat treatment chamber 100, and the operation of the above-mentioned heat treatment is repeated.

In this embodiment, the pressure within the heat treatment chamber 100 for plasma generation is set to 0.6 atmospheric pressure. However, the same operation is enabled even under the atmospheric pressure of 10 atmospheric pressure or lower. If the pressure exceeds 10 atmospheric pressure, even glow discharge is difficult to generate. In this embodiment, He gas is used in the raw gas for plasma generation. In addition, the same advantages are obtained even if a gas using an inert gas such as Ar, Xe, or Kr as a main raw material is used. The He gas used in this embodiment is excellent in the plasma ignition and stability under the substantially atmospheric pressure. However, the thermal conductivity of the gas is high, and the heat loss due to heat transfer through the gas atmosphere is relatively large. On the other hand, a gas large in mass such as Ar, Xe, or Kr gas is low in the thermal conductivity, and therefore superior to the He gas from the viewpoint of the thermal efficiency.

Further, in this embodiment, the radiation loss from each of the upper electrode 102, the lower electrode 103, and the stage 104 is reduced by the heat shields 401, and the radiation light is returned to the upper electrode 102 and the lower electrode 103 by each of the upper reflecting mirror 120a, the side reflecting mirror 120b, and the lower reflecting mirror 120c, thereby being capable of improving the heating efficiency. Even if only the heat shields 401 are applied to the upper electrode 102 and the lower electrode 103, an improvement in the heating efficiency can be expected. Likewise, even if only the upper reflecting mirror 120a, the side reflecting mirror 120b, and the lower reflecting mirror 120c are applied thereto, an improvement in the heating efficiency can be expected.

In this embodiment, the heat release from each of the upper electrode 102 and the lower electrode 103, which affects the heating efficiency mainly includes (1} radiation, (2) heat transfer of gas atmosphere, and (3) heat transfer from the upper feed line 110 and the lower electrode 103. When the heat treatment is conducted at 1200° C. or higher, a main factor of the heat release largest among those factors is (1) radiation.

From the above viewpoints, in this embodiment, in order to suppress the radiation of (1), the heat shields 401 are disposed on opposite sides of the surfaces of the upper electrode 102 and the lower electrode 103, which are exposed to the plasma 124. Also, in order to minimize the radiation loss, the protective film 430 which is a protective material for preventing the contamination from each of the upper reflecting mirror 120a, the side reflecting mirror 120b, and the lower reflecting mirror 120c is coated on each of the upper reflecting mirror 120a, the side reflecting mirror 120b, and the lower reflecting mirror 120c.

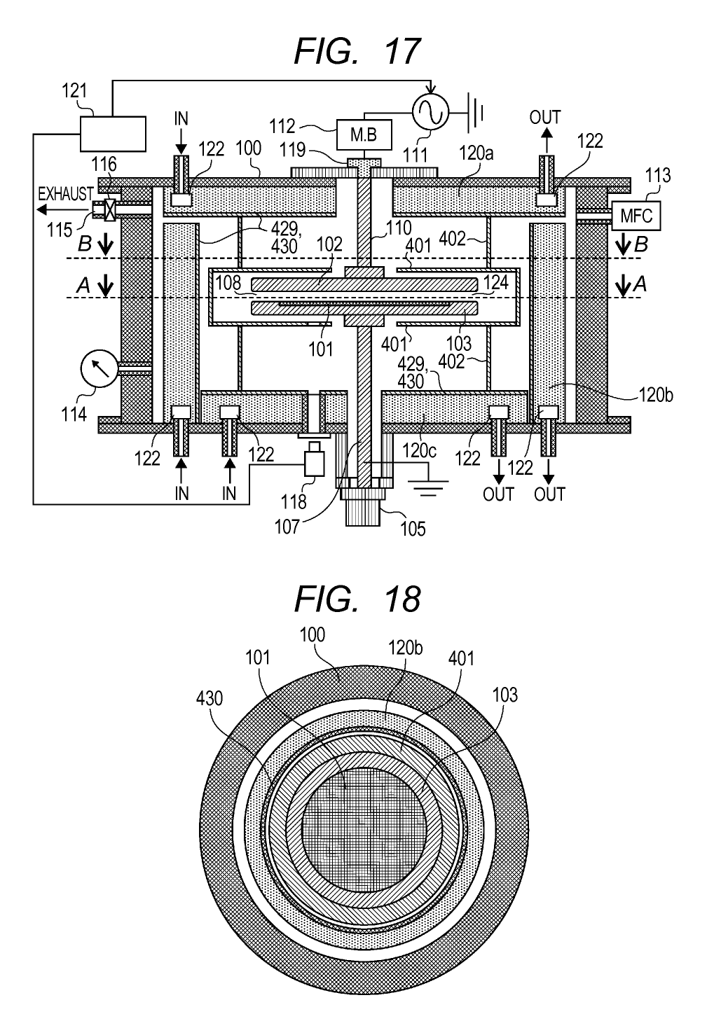

Also, with the configuration of this embodiment, a reduction in the thermal efficiency due to the radiation of (1) can be suppressed, and a reduction in the thermal efficiency due to the electric discharge generated except for the gap between the upper electrode 102 and the lower electrode 103 can be also suppressed. For that reason, when the electric discharge generated except for the gap between the upper electrode 102 and the lower electrode 103 can be suppressed under the heat treatment condition, with a configuration illustrated in FIG. 17, a reduction in the thermal efficiency due to the radiation of (1) can be suppressed, and the radiation loss is minimized. FIG. 17 is a longitudinal cross-sectional view of an outline of the heat treatment chamber 100, and in FIG. 17, parts indicated by the same symbols in FIG. 14 have the same functions as those in the heat treatment chamber 100 of FIG. 14 in this embodiment, and therefore a description thereof will be omitted.

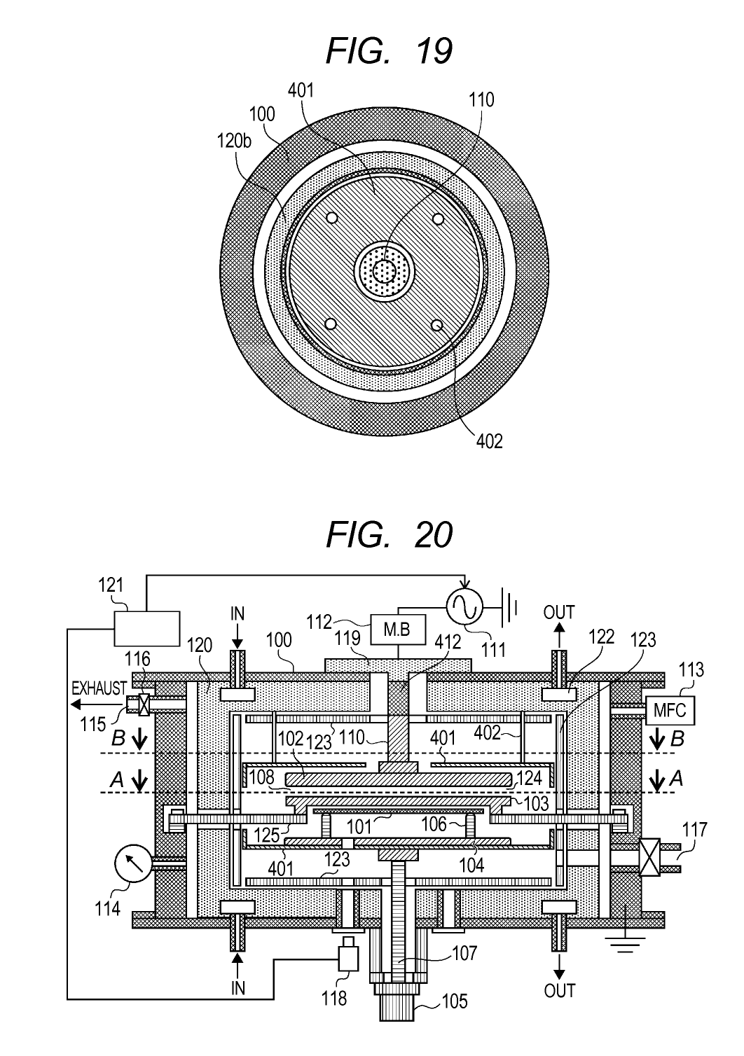

A difference between the heat treatment chamber 100 illustrated in FIG. 17 and the heat treatment chamber 100 illustrated in FIG. 14 resides in that only the surface of the metal base material 432 which faces the surfaces of the upper reflecting mirror 120a, the side reflecting mirror 120b, and the lower reflecting mirror 120c disposed within the heat treatment chamber 100 illustrated in FIG. 17 where a large amount of radiation heat is generated as illustrated in FIGS. 13, and 17 to 19 is optically polished, and the surface optically polished is plated with the metal film 429 of the low radiation, or coated with the metal film 429 through vapor deposition. Further, the protective film 430 is coated on the metal film 429 of the low radiation. FIG. 18 is a top view taken along a cross-section A-A in FIG. 17, and FIG. 19 is a top view taken along a cross-section B-B in FIG. 17. Also, FIG. 13 is a schematic diagram illustrating the upper reflecting mirror 120a, the side reflecting mirror 120b, and the lower reflecting mirror 120c.

Hereinafter, the advantages of this embodiment are summarized. In the heat treatment apparatus according to the present invention, the specimen 101 to be heated is heated with the gas heating associated with the glow discharge generated in the narrow gap as the heat source. The following two advantages indicated below which are not obtained in the related art are obtained with this heating principle.

A first advantage resides in the thermal efficiency. The gas in the gap 108 is extremely small in the heat capacity. Also, the heat shields 401 are arranged between each of the upper electrode 102 and the lower electrode 103, and each of the upper reflecting mirror 120a, the side reflecting mirror 120b, and the lower reflecting mirror 120c. Also, as a protective material for preventing the contamination from each of the upper reflecting mirror 120a, the side reflecting mirror 120b, and the lower reflecting mirror 120c, the protective film 430 is coated on each surface of the upper reflecting mirror 120a, the side reflecting mirror 120b, and the lower reflecting mirror 120c. With this configuration, the specimen 101 to be heated can be heated with a system in which the heating loss attributable to the radiation is extremely reduced.

A second advantage resides in the productivity. In the heat treatment apparatus according to the present invention, in each of the upper reflecting mirror 120a, the side reflecting mirror 120b, and the lower reflecting mirror 120c, the protective film 430 is coated on the surface of the metal film 429 of the low radiation which has been plated or evaporated which can be a contamination source. As a result, the contamination source can be covered directly with the protective film 430 to prevent the contamination, and improve the yield property.

From the above viewpoints, the heat treatment apparatus according to the present invention can enhance the thermal efficiency and the yield property even if the specimen to be heated is heated at 1200° C. or higher.

### Fourth Embodiment

This embodiments pays attention to an upper feed line. An isotropic graphite material of a member used for the upper feed line is a relatively high thermal conductivity to the same degree as that of iron, and therefore the heat loss caused by the thermal conduction from the upper electrode becomes large. Also, because the power introduction terminal connecting the outside and inside of the processing chamber is low in heat resistance, the power introduction terminal is deteriorated by the heat, and cannot stably operate if a large temperature gradient cannot be produced within the component of the upper feed line.

From the viewpoint of the above problems, in this embodiment, a description will be given of a heat treatment apparatus high in the thermal efficiency and the yield property even when the specimen to be heated is heated at 1200° C. or higher. The matters described in the first to third embodiments but not described in this embodiment can be also applied to this embodiment unless special circumstances exist.

A basic configuration of the heat treatment apparatus according to this embodiment will be described with reference to FIG. 20.

The heat treatment apparatus according to this embodiment includes the heat treatment chamber 100 that heats the specimen 101 to be heated with the use of the plasma 124.

The heat treatment chamber 100 includes the upper electrode 102, the lower electrode 103 which is a heating plate facing the upper electrode 102, the beams 125 that support the lower electrode 103, and the stage 104 having the support pins 106 for supporting the specimen 101 to be heated. The heat treatment chamber 100 also includes the heat shields 401 that reduce the radiation loss, the support rods 402 that support the heat shields 401, the reflecting mirror 120 that reflects the radiation heat, the radio-frequency power supply 111 that supplies the radio-frequency power for plasma generation to the upper electrode 102, the gas introducing means 113 that supplies the gas into the heat treatment chamber 100, and the vacuum valve 116 that adjusts a pressure within the heat treatment chamber 100.

The specimen 101 to be heated is supported on the support pins 106 of the stage 104, and arranged closely below the lower electrode 103. Also, the lower electrode 103 comes out of contact with the specimen 101 to be heated, and the stage 104. In this embodiment, an SiC substrate of 6 inches (φ150 mm) is used as the specimen 101 to be heated. A diameter and a thickness of the upper electrode 102 and the stage 104 are set to 200 mm and 5 mm, respectively.

On the other hand, a diameter of the lower electrode 103 is equal to or lower than an inner diameter of the reflecting mirror 120, and a thickness of the lower electrode 103 is set to 2 mm.

Also, the lower electrode 103 has an inner cylindrical member configured to cover the side surface of the specimen 101 to be heated on an opposite side of a surface facing the upper electrode 102. As illustrated in a cross-section A-A of FIG. 20, the lower electrode 103 includes a disc-shaped member substantially identical in diameter with the upper electrode 102, and four beams 125 arranged at regular intervals so as to connect the above disc-shaped member to the heat treatment chamber 100. Also, the number, the cross-sectional area, and the thickness of the above beams 125 can be determined taking a strength of the lower electrode 103, and the radiation from the lower electrode 103 toward the heat treatment chamber 100 into account.

Because of a structure illustrated in FIG. 7, the lower electrode 103 can inhibit the heat of the lower electrode 103 heated by the plasma 124 from being transferred to the reflecting mirror 120, and therefore functions as the heating plate high in the thermal efficiency. Further, the plasma 124 generated between the upper electrode 102 and the lower electrode 103 is diffused into the vacuum valve 116 side from a space between the respective beams. However, because the specimen 101 to be heated is covered with the inner cylindrical member, the specimen 101 to be heated is not exposed to the plasma 124.

Also, the upper electrode 102, the upper feed line 110, the lower electrode 103, the beams 125, the stage 104, and the support pins 106 are each obtained by depositing SiC on a surface of an isotropic graphite base material through a chemical vapor deposition (hereinafter referred to as “CVD technique”).

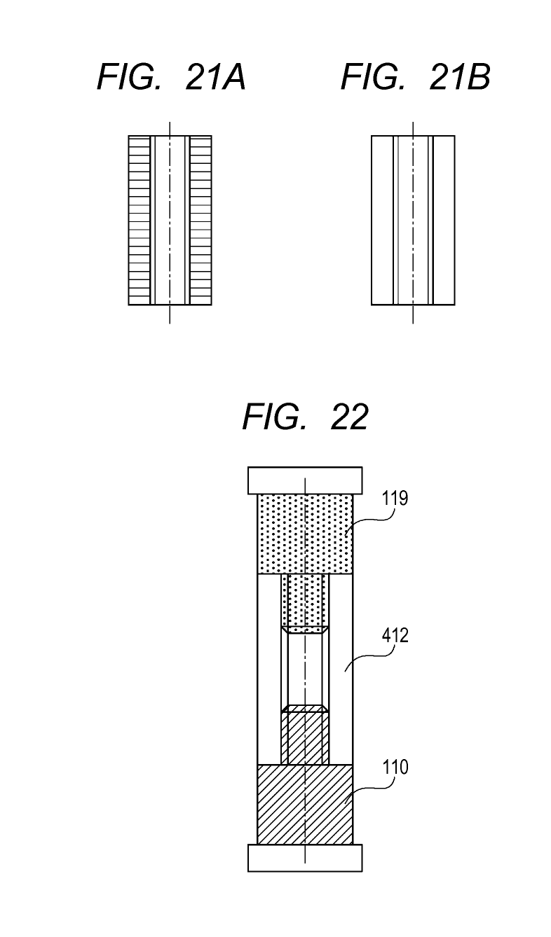

FIGS. 21A and 21B illustrate detailed diagrams of a relay feed line 412. The relay feed line 412 is made of any one of carbon fiber reinforced-carbon matrix-composite (FIG. 21A), and glassy carbon (FIG. 21B), which are graphite material of the low thermal conduction as compared with isotropic graphite base material, and a center of the relay feed line 412 is machined into an internal thread.

In general, the thermal conductivity of the isotropic graphite base material is about 70 to 140/(K·m).

On the contrary, the carbon fiber reinforced-carbon matrix-composite is made of an anisotropic material in which a thermal conductivity in a direction perpendicular to fibers is 5 to 15 W/(K·m), a thermal conductivity in a direction parallel to the fibers is 30 to 60 W/(K·m), and because the direction perpendicular to the fibers is particularly low in thermal conduction, the longitudinal direction is perpendicular to the fibers in manufacturing the relay feed line 412 made of the carbon fiber reinforced-carbon matrix-composite.

Also, the glassy carbon is an isotropic material which is 5 to 10 W/(K·m) in the thermal conductivity.

Since both of those materials are low in the thermal conductivity by about 5 to 25 times as compared with the isotropic graphite material, the heat loss from the upper feed line 110 can be reduced.

Also, with the use of the graphite material of the low thermal conductivity, the heat loss transferred between the upper electrode 102 and the power introduction terminal 119 is suppressed, and with the use of the low thermal conductivity, because a large temperature gradient can be formed within the component of the relay feed line 412, a rise in the temperature of the power introduction terminal 119 can be avoided, and the thermal deterioration can be avoided.

Also, even if the relay feed line 412 and the upper feed line 110 are positionally replaced with each other, the equivalent advantages are obtained.

FIG. 22 illustrates a connection diagram of the relay feed line 412. The power introduction terminal 119 and the upper feed line 110 are externally threaded on the relay feed line 412 side, and coupled with the internal thread of the relay feed line 412.

The heat of the upper electrode 102 is transferred through the upper feed line 110 and the relay feed line 412, and lost. Hence, the heat transfer from the upper feed line 110 needs to be minimized.

Hence, the cross-sections of the upper feed line 110 made of the isotropic graphite material, and the relay feed line 412 made of glassy carbon need to be as small as possible, and the lengths thereof needs to be longer. However, if the cross-sections of the upper feed line 110 and the relay feed line 412 are extremely small, and the lengths are too long, the radio-frequency power losses of the upper feed line 110 and the relay feed line 412 become large, and the heating efficiency of the specimen 101 to be heated are lowered.

Also, because the glassy carbon is expensive as compared with the isotropic graphite material, if the relay feed line 12 is too long without any reason, the costs become high.

Also, the carbon fiber reinforced-carbon matrix-composite is a member made by lapping fibers, which is weak in thickening the fibers toward the longitudinal direction. Therefore, the carbon fiber reinforced-carbon matrix-composite is unsuited for manufacturing the too long relay feed line 412.

For that reason, in this embodiment, from the above viewpoints, the cross-section of the relay feed line 412 made of the glassy carbon or the carbon fiber reinforced-carbon matrix-composite is set to 12 mm², and the length thereof is set to 40 mm.

The same advantages are obtained even when the cross-section of the relay feed line 412 ranges from 50 mm² to 170 mm², and the length of the relay feed line 412 ranges from 20 mm to 80 mm.

Also, the gap 108 formed between the lower electrode 103 and the upper electrode 102 is set to 0.8 mm. The specimen 101 to be heated has a thickness of about 0.5 mm to 0.8 mm. Also, the circumferential corner portions of the respective facing sides of the upper electrode 102 and the lower electrode 103 are tapered or rounded. This is because the plasma localization on the respective corner portions of the upper electrode 102 and the lower electrode 103 due to the concentration of an electric field is suppressed. The stage 104 is connected to the lifting mechanism 105 through the shaft 107, and the lifting mechanism 105 is operated to enable the specimen 101 to be heated to be delivered, and the specimen 101 to be heated to come closer to the lower electrode 103. Also, the shaft 107 is made of an alumina material.

The radio-frequency power is supplied to the upper electrode 102 from the radio-frequency power supply 111 through the relay feed line 412 and the upper feed line 110. In this embodiment, a frequency of the radio-frequency power supply 111 is 13.56 MHz.

In this embodiment, corner portions of the upper surface of the reflecting mirror 120 are covered with the protective quartz plates (shields) 123, and an insulating disc to suppress the electric discharge liable to be generated in the corner portions.

The lower electrode 103 is electrically connected to the heat treatment chamber 100 through the beams 125. Further, the lower electrode 103 is grounded to the beams 125 through the heat treatment chamber 100.

The matching circuit 112 (M.B in FIG. 20 is an abbreviation for matching box) is arranged between the radio-frequency power supply 111 and the upper electrode 102, and the radio-frequency power from the radio-frequency power supply 111 is efficiently supplied to the plasma 124 formed between the upper electrode 102 and the lower electrode 103.

The gas can be introduced in a range of from 0.1 atmospheric pressure to 10 atmospheric pressure into the heat treatment chamber 100 in which the upper electrode 102 and the lower electrode 103 are arranged, by the gas introducing means 113. A pressure of the introduced gas is monitored by the pressure detecting means 114. Also, the heat treatment chamber 100 can exhaust gas by the aid of a vacuum pump connected to an exhaust port 115 and the vacuum valve 116.

The upper electrode 102, the lower electrode 103, and the stage 104 within the heat treatment chamber 100 are structured to be surrounded by the reflecting mirror 120. The reflecting mirror 120 is formed by optically polishing an inner wall surface of a metal base material, and plating or evaporating gold on the polished surface.

Also, the cooling passage 122 is formed in the metal base material of the reflecting mirror 120, and the cooling water is allowed to flow into the cooling passage 122 whereby the temperature of the reflecting mirror 120 can be maintained at a constant temperature. Because the radiation heat from the upper electrode 102, the lower electrode 103, and the stage 104 are reflected with the provision of the reflecting mirror 120, the thermal efficiency can be enhanced, but the reflecting mirror 120 is not essential.

The protective quartz plates (shields) 123 are arranged between the heat shields 401 and the reflecting mirror 120. The protective quartz plates (shields) 123 has functions of preventing the contamination on the reflecting mirror 120 surface due to the emissions (sublimation of graphite) from the upper electrode 102, the lower electrode 103, and the stage 104 which are at an ultrahigh temperature, and preventing contamination likely to be mixed into the specimen 101 to be heated from the reflecting mirror 120.

In general, a mechanism of the heat transfer mechanism can be classified into three sub-mechanisms of (1) heat conduction, (2) radiation, and (3) heat transfer by convection. When the temperature is about 700° C. or higher, (2) the heat transfer by the radiation is mainstream.

Further, in this embodiment, the heat shields 401 are disposed on opposite sides of the surfaces of the upper electrode 102, the lower electrode 103, and the stage 104, which are exposed to the plasma 124. With this configuration, because the radiation heat from the upper electrode 102, the lower electrode 103, and the stage 104 is reduced, the thermal efficiency can be enhanced.

Subsequently, a basic operation example of the heat treatment apparatus according to this embodiment will be described.

First, the He gas within the heat treatment chamber 100 is exhausted from the exhaust port 115 into a high vacuum state. In a stage where the sufficient gas exhaust has been finished, the exhaust port 115 is closed, the gas is introduced by the gas introducing means 113, and the interior of the heat treatment chamber 100 is controlled to 0.6 atmospheric pressure. In this embodiment, the gas introduced into the heat treatment chamber 100 is He.

The specimen 101 to be heated preheated in a spare chamber (not shown) at 400° C. is transported from the transport port 117, and supported on the support pins 106 of the stage 104.

After the specimen 101 to be heated has been supported on the support pins 106 of the stage 104, the stage 104 is lifted up to a given position by the aid of the lifting mechanism 105. In this embodiment, the given position is set to a position at which a distance between a lower surface of the lower electrode 103 and the surface of the specimen 101 to be heated is 0.5 mm.

In this embodiment, the distance between the lower surface of the lower electrode 103 and the surface of the specimen 101 to be heated is set to 0.5 mm, but may range from 0.1 mm to 2 mm. The thermal efficiency becomes higher as the specimen 101 to be heated comes closer to the lower surface of the lower electrode 103.

However, a risk that the lower electrode 103 and the specimen 101 to be heated come into contact with each other becomes higher, or a problem on contamination more occurs as the specimen 101 to be heated comes closer to the lower surface of the lower electrode 103. Therefore, it is not preferable that the above distance is lower than 0.1 mm. Also, it is not preferable that the distance is larger than 2 mm, because the heating efficiency is lowered, and the radio-frequency power necessary for heating becomes large. For that reason, the proximity in this embodiment is set to the distance of from 0.1 mm to 2 mm.

After the stage 104 has been lifted to the given position, the radio-frequency power from the radio-frequency power supply 111 is supplied to the upper electrode 102 through the matching circuit 112 and a power introduction terminal 119, and the plasma 124 is generated within the gap 108 to heat the specimen 101 to be heated. An energy of the radio-frequency power is absorbed by electrons within the plasma 124, and atoms or molecules of a raw gas are heated by collision of the electrons. Also, ions generated by ionization are accelerated by a potential difference generated in a sheath on the surfaces of the upper electrode 102 and the lower electrode 103 which come into contact with the plasma, and are input to the upper electrode 102 and the lower electrode 103 while colliding with the raw gas. Through the above collision process, the temperature of the gas filled between the upper electrode 102 and the lower electrode 103, and the temperatures of the surfaces of the upper electrode 102 and the lower electrode 103 can be raised.

In particular, in the almost atmospheric pressure as in this embodiment, since the ions frequently collide with the raw gas when passing through the sheath, the raw gas filled between the upper electrode 102 and the lower electrode 103 can be efficiently heated.

As a result, the temperature of the raw gas can be easily heated up to about 1200 to 2000° C. The upper electrode 102 and the lower electrode 103 are heated by bringing the heated high-temperature gas into contact with the upper electrode 102 and the lower electrode 103. Also, a part of a neutral gas excited by the electron collision is deexcited with light emission, and the upper electrode 102 and the lower electrode 103 are also heated by the light emission in this situation. Further, the stage 104 and the specimen 101 to be heated are heated by going-around of the high-temperature gas, and the radiation from the upper electrode 102 and the lower electrode 103 which have been heated.

In this example, since the lower electrode 103 that is the heating plate is disposed closely above the specimen 101 to be heated, the specimen 101 to be heated is heated after the lower electrode 103 has been heated by the gas heated at a high temperature by the aid of the plasma 124, to thereby obtain an advantage that the specimen 101 to be heated is evenly heated. Also, with the provision of the stage 104 below the lower electrode 103, an even electric field is formed between the lower electrode 103 and the upper electrode 102 regardless of a configuration of the specimen 101 to be heated, thereby enabling the uniform plasma to be generated. Further, the specimen 101 to be heated is arranged below the lower electrode 103, as a result of which the specimen 101 to be heated is not exposed directly to the plasma 124 formed in the gap 108. Also, even when the discharge transitions from the glow discharge to the arc discharge, a discharge current flows into the lower electrode 103 without passing through the specimen 101 to be heated. As a result, the specimen 101 to be heated can be prevented from being damaged.

The temperature of the lower electrode 103 or the stage 104 during the heat treatment is measured by the radiation thermometer 118, and an output of the radio-frequency power supply 111 is controlled so that the above temperature reaches a given temperature by a control device 121 with the use of a measured value. Therefore, the temperature of the specimen 101 to be heated can be controlled with a high precision. In this embodiment, the radio-frequency power to be input is set to 20 kW at the maximum.

Also, the plasma 124 of the heating source is set as plasma in a grow discharge region so that the plasma 124 evenly spread can be formed between the upper electrode 102 and the lower electrode 103, and the specimen 101 to be heated is heated with the even and planar plasma 124 as a heat source so that the planar specimen 101 to be heated can be evenly heated.

Upon completion of the above heat treatment, in a stage where the temperature of the specimen 101 to be heated falls below 800° C., the specimen 101 to be heated is carried out of the transport port 117, a subsequent specimen 101 to be heated is transported into the heat treatment chamber 100, and supported on the support pins 106 of the stage 104, and the operation of the above-mentioned heat treatment is repeated.

In this embodiment, the pressure within the heat treatment chamber 100 for plasma generation is set to 0.6 atmospheric pressure. However, the same operation is enabled even under the atmospheric pressure of 10 atmospheric pressure or lower. If the pressure exceeds 10 atmospheric pressure, even glow discharge is difficult to generate.

In this embodiment, He gas is used in the raw gas for plasma generation. In addition, the same advantages are obtained even if a gas using an inert gas such as Ar, Xe, or Kr as a main raw material is used. The He gas used in this embodiment is excellent in the plasma ignition and stability under the substantially atmospheric pressure. However, the thermal conductivity of the gas is high, and the heat loss due to heat transfer through the gas atmosphere is relatively large. On the other hand, a gas large in mass such as Ar, Xe, or Kr gas is low in the thermal conductivity, and therefore superior to the He gas from the viewpoint of the thermal efficiency.

In this embodiment, the radiation loss from each of the upper electrode 102, the lower electrode 103, and the stage 104 is reduced by the heat shields 401, and the radiation light is returned to the upper electrode 102, the lower electrode 103, and the stage 104 by the reflecting mirror 120, thereby being capable of improving the heating efficiency. However, even if only the heat shields 401 are applied to the upper electrode 102, the lower electrode 103, and the stage 104, an improvement in the heating efficiency can be expected. Likewise, even if only the reflecting mirror 120 is installed, an improvement in the heating efficiency can be expected.

In this embodiment, a radio-frequency power supply of 13.56 MHz is used in the radio-frequency power supply 111 for the plasma generation. This is because since 13.56 MHz is an industrial frequency, the power supply is available at low costs, and a standard for electromagnetic wave leakage is also low, thereby being capable of reducing the device costs. However, in principle, it is needless to say that the heat treatment can be conducted at another frequency in the same principle. In particular, a frequency of 1 MHz or higher and 100 MHz or lower is preferable. When the frequency is lower than 1 MHz, a radio-frequency voltage when supplying an electric power necessary for the heat treatment becomes high, an abnormal discharge (unstable plasma or electric discharge except for the gap between the upper electrode and the lower electrode) is generated, thereby making it difficult to generate stable plasma. Also, in a frequency exceeding 100 MHz, an impedance in the gap 108 between the upper electrode 102 and the lower electrode 103 is low, thereby making it difficult to obtain a voltage necessary for the plasma generation. Therefore, such a frequency is not desirable.

Hereinafter, the advantages of this embodiment are summarized. In the heat treatment apparatus according to the present invention, the specimen 101 to be heated is heated with the gas heating associated with the atmospheric pressure glow discharge generated in the narrow gap as the heat source. The following two advantages indicated below which are not obtained in the related art are obtained with this heating principle.

A first advantage resides in the thermal efficiency. The carbon material of the low thermal conduction is arranged between the upper electrode 102 and the power introduction terminal 119 thereby being capable of suppressing the heat transfer from the upper electrode, and efficiently heating the specimen to be heated.

A second advantage resides in the productivity. When the carbon material of the low thermal conduction is arranged between the upper electrode 102 and the power introduction terminal 119, the large temperature gradient can be produced within the relay feed line 412, and the power-on terminal can be prevented from being deteriorated by heat.

For that reason, the present invention can obtain the above-mentioned advantages.

The present invention has been described in detail above, and the main configurations of the present invention will be described below.

(1) A heat treatment apparatus, including:

a heat treatment chamber that conducts a heat treatment on a specimen to be heated by the aid of plasma;

a radio-frequency power supply that supplies a radio-frequency power for forming the plasma;

a first electrode that is arranged within the heat treatment chamber, and supplied with the radio-frequency power

a second electrode that is arranged within the heat treatment chamber, faces the first electrode, and forms the plasma in cooperation with the first electrode; and

a reflecting mirror that is arranged within the heat treatment chamber, and reflects a radiation heat,

in which the reflecting mirror has a laminated film in which a metal film of a low radiation, and a protective film are sequentially formed on a surface facing the radiation heat.

(2) The heat treatment apparatus that conducts the heat treatment on the specimen to be heated, further including:

a thermal expansion absorption member that absorbs a thermal expansion of a first member that is to be heated and thermally expands, and connects the first member to a second member not to be heated,

in which the thermal expansion absorption member has an elastic member made of an elastic material.

The present invention is not limited to the above embodiments, but includes a variety of modified examples. For example, in the above-mentioned embodiments, in order to easily understand the present invention, the specific configurations are described. However, the present invention does not always provide all of the configurations described above. Also, a part of one configuration example can be replaced with another configuration example, and the configuration of one embodiment can be added with the configuration of another embodiment. Also, in a part of the respective configuration examples, another configuration can be added, deleted, or replaced.

What is claimed is:

1. A heat treatment apparatus, comprising:
a heat treatment chamber that conducts a heat treatment on a specimen to be heated by the aid of plasma;
a radio-frequency power supply that supplies a radio-frequency power for forming the plasma;
a first electrode that is arranged within the heat treatment chamber, and supplied with the radio-frequency power
a second electrode that is arranged within the heat treatment chamber, faces the first electrode, and forms the plasma in cooperation with the first electrode; and
a reflecting mirror that is arranged within the heat treatment chamber, and reflects a radiation heat,
wherein the reflecting mirror has a laminated film in which a metal film of a low radiation, and a protective film are sequentially formed on a surface facing the radiation heat.

2. The heat treatment apparatus according to claim 1,
wherein the metal film of the low radiation is a gold film, and
wherein the protective film is a film made of a material selected from a group of quartz, calcium fluoride, sapphire, barium fluoride, lithium fluoride, and magnesium fluoride.

3. The heat treatment apparatus according to claim 2,
wherein the protective film is a quartz film, and a thickness of the quartz film is a value ranging from 0.1 μm to 10 μm.

4. The heat treatment apparatus according to claim 3, further comprising: cooling means for cooling the reflecting mirror.

5. The heat treatment apparatus according to claim 1, further comprising:
a feed line that supplies a radio-frequency power from the radio-frequency power supply to the first electrode,
wherein the feed line includes a first feed line, and a second feed line having a thermal conductivity lower than that of the first feed line.

6. The heat treatment apparatus according to claim 5,
wherein the first feed line is connected to the first electrode, and made of an isotropic graphite material, and
wherein the second feed line is connected to the first electrode through the first feed line, and made of carbon fiber reinforced-carbon matrix-composite, or glassy carbon.

7. The heat treatment apparatus according to claim 6,
wherein the second feed line is made of carbon fiber reinforced-carbon matrix-composite, and
wherein a direction of fibers of the carbon fiber reinforced-carbon matrix-composite is perpendicular to a longitudinal direction of the second feed line.

8. The heat treatment apparatus according to claim 5, further comprising: a thermal expansion absorption member that absorbs a thermal expansion of the second electrode,
wherein the second electrode has a beam, and is connected to the heat treatment chamber through the beam and the thermal expansion absorption member, and
wherein the thermal expansion absorption member has an elastic member.

9. The heat treatment apparatus according to claim 8,
wherein the thermal expansion absorption member has a base, and
wherein the base is made of stainless steel.

10. A heat treatment apparatus that conducts a heat treatment on a specimen to be heated, comprising:
a thermal expansion absorption member that absorbs a thermal expansion of a first member which is to be heated and thermally expands, and connects the first member to a second member which is not to be heated,
wherein the thermal expansion absorption member includes an elastic member made of an elastic material.
